(19) United States
(12) Patent Application Publication
(10) Pub. No.: US 2016/0363957 A1
(43) Pub. Date: Dec. 15, 2016

(54) WEARABLE COMPUTER WITH ELECTRONIC STRAP AND ATTACHMENT THEREFOR

(71) Applicant: Christian Stroetmann, Moers (DE)

(72) Inventor: Christian Stroetmann, Moers (DE)

(21) Appl. No.: 14/734,901

(22) Filed: Jun. 9, 2015

(51) Int. Cl. G06F 1/16; H02J 7/02; G06F 1/18

(52) U.S. Cl. CPC G06F 1/163; G06F 1/189; H02J 7/025

(57) ABSTRACT

Embodiments of a wearable computer are disclosed. The wearable computer comprises an electronic module, a central portion for housing the electronic module, a strap for wearing the portable electronic device on a body part of a user, at least one electrical energy storage device embedded within the strap, and an attachment for mechanically fastening and electrically coupling the electronic strap to the central portion. In some embodiments, the wearable computer can have a display, a means for wirelessly charging the energy storage device, different materials for the electronic strap, and a clasp means. In some embodiments, the wearable electronic device can be removably coupled to the electronic strap. This permits the wearable computer to provide a long runtime and to assume novel configurations.

### BACKGROUND

1. Field of the Disclosure

The present application relates generally to portable information processing devices worn on a body part of a user by a strap, band, bracelet, or belt. More particularly, the present invention pertains to central portions and cases containing an electronic module, to electronic straps, bands, bracelets, or belts having embedded at least one electrical energy storage device, and to attachments for fastening and coupling the electronic straps, bands, or belts to the central portions and cases of such wearable computers.

2. Description of the Related Art

Portable electronic devices are commonplace today. Some examples of portable electronic devices include portable digital assistants, portable media players, radio receivers, pagers, mobile telephones, and portable game consoles.

Some of these portable electronic devices are suitable on the one hand to be mounted respectively worn on a body part of a user, such as the wrist, arm, head, shoulder, and hip for example, and on the other hand to process arbritary informations and to execute arbritary programs stored in the memory. Such body-worn information processing devices respectively wearable computers are available in various types, such as a wrist watch respectively smart watch, a pair of glasses and goggles respectively smart eyewear and optical head-mounted display, and a belt respectively smart belt to give some few examples.

These body-worn computing devices contain, in addition to the essential components as for example a wrist watch, a pair of glasses and goggles, and a belt, a variety of electronic circuits, such as a variety of user interfaces for providing ways of operation by a user or/and a variety of sensors for measuring a surrounding environment, a processor for performing general and special information processing, a memory function for storing programs and input data from the outside, a display for presenting changeable visual informations, and so on to provide a variety of additional functions others than a time display function, an eye protection function, or just an aesthetic function.

As one consequence of the increased functionalities, performances, and demands of a user, the need for electric power to run wearable computers increased as well, which makes it inevitable for such devices to supply larger electric energy sources respectively batteries due to the limited energy density of a battery. Other consequences are the increased needs for more space to house the electronic components and for more aesthetical appearance to meet the demands of a user in this relation as well.

A general solution for these various needs is to exploit all suitable essential parts of a body-worn electronic device for the arrangement of the electronic components, specifically all kinds of electrically conductive members and the electrical energy storage devices respectively batteries. A prominent example of such an essential part in the case of a wrist-worn electronic apparatus is the wristband, which is the object of various disclosed inventions that solve the problems and needs to some extent in regard to such devices. In this respect, some former inventions are only related with electronic wristbands.

In U.S. Pat. No. 8,459,825, issued Jun. 11, 2013, and entitled “Aesthetic device for providing of electrical power to external electronic devices”, and U.S. Pat. No. 8,624,554, issued Jan. 7, 2014, and entitled “Solar bracelet”, electronic wristbands with one or more battery cells, control electronics, and plugs to connect the electronic wristbands with external electronic devices are disclosed. Further inventions already disclosed in this respect are only related with conventional wrist watch-type electronic apparatuses, specifically electronic watches or digital watches with additional functional components, like for example thermometer, pulse rate meter, calculator, data bank, audio player, radio set respectively radio circuitry, including Frequency Modulation (FM) receiver, paging device, and radiotelephone, as well as altimeter, Global Positioning System (GPS), and keyboard, but not with general body-worn information processing systems respectively wearable computers.

In U.S. Pat. No. 3,971,206, issued Jul. 27, 1976, and entitled “Distributed watch”, an electronic watch respectively digital watch with one or more batteries embedded in the wristband is disclosed.

In U.S. Pat. No. 5,615,179, issued Mar. 25, 1997, and entitled “Electronic apparatus with fitting band”, non-metallic materials, such as natural leather, artificial leather, insulating high-molecular resins, and elastomer fibers, and metallic materials, as well as structures of wristbands, which are conventionally used in wrist watch-type electronic apparatuses and which contain conductive members therein, structures of mountings respectively attachments for fastening a band to the case of a wrist watch-type electronic apparatus, and structures of band mounting portions of the case of a wrist watch-type electronic apparatus are cited and disclosed. This also comprises wristbands made of links including conductive wires and batteries therein.

In U.S. Pat. No. 3,032,651, issued May 1, 1962, and entitled “Wrist carried radio set”, and U.S. Pat. No. 5,159,713, issued Oct. 27, 1992, and entitled “Watch pager and wrist antenna”, wrist watch-type electronic apparatuses with radio circuitries and common mounting structures based on conventional pins and spring loaded pins respectively spring bars for attaching the bands respectively straps to the device cases and simultaneously connecting the antennas embedded in the bands with the electronic circuitries housed inside the cases of the wrist watch-type electronic apparatuses are disclosed.

In U.S. Pat. No. 5,450,091, issued Sep. 12, 1995, and entitled “Variable size antenna device having resonance frequency compensation”, a wrist watch-type electronic apparatus with radio circuitry and a common mounting structure based on conventional screws for attaching the band respectively strap to the device case and simultaneously connecting the antenna embedded in the band with the electronic circuitry housed inside the case of the wrist watch-type electronic apparatus is disclosed.

In U.S. Pat. No. 5,742,256, issued Apr. 21, 1998, and entitled “Wristband having embedded electrically conductive members for a wrist-mountable type electronic device”, and U.S. Pat. No. 6,854,978, issued Feb. 15, 2005, and entitled “Portable electronic device including means for establishing an electrical connection inside a case of said device”, wrist watch-type electronic apparatuses with radio circuitries and common mounting structures based on a conventional plug-in mechanism with pins or screws for attaching the bands respectively straps to the device cases and simultaneously connecting the antennas embedded in the bands with the electronic circuitries housed inside the cases of the wrist watch-type electronic apparatuses are disclosed.

In U.S. Pat. No. 4,922,260, issued May 1, 1990, and entitled “Adjustable watchband with embedded antenna”, a wrist watch-type electronic apparatus with a radio circuitry and a mounting structure based on a slide-in mechanism for attaching the band respectively strap to the device case and simultaneously connecting the antenna embedded in the band with the electronic circuitry housed inside the case of the wrist watch-type electronic apparatus is disclosed.

In U.S. Pat. No. 4,141,074, issued Feb. 20, 1979, and entitled “Electronic wrist calculator”, a wrist watch with calculator and wristband links including a keyboard and one or more batteries is disclosed.

In U.S. Pat. No. 5,872,744, issued Feb. 16, 1999, and entitled “Battery arrangement for a wrist-carried radiotelephone”, a wrist watch-type electronic apparatus with radio circuitry and a wristband is disclosed, with the wristband having links each containing a battery therein.

In U.S. Pat. No. 8,908,479, issued Dec. 9, 2014, and entitled “Electronic wrist watch having wireless charging function”, a common digital wrist watch with auxiliary functions, one battery contained within the watch case or/and one flexible thin-film battery embedded within the wristband in combination with a wireless charging system based on inductive coupling is disclosed.

Also known by those skilled in the art is the flexible digital wrist watch “Time-It” with an unconventional display for indicating the time based on Light-Emitting Diodes (LEDs), which features such a wireless charging system.

Several more inventions already disclosed in this respect are related with wearable information processing devices, specifically digital watches and smart watches, but no details about truly practical attachments or/and common clasps or buckles are given.

In U.S. Pat. No. 6,619,835, issued Sep. 16, 2003, and entitled “Body wearable information processing terminal device”, a wrist watch-type wearable computer with a wristband and one or more function modules including for example a battery and being mountable on the wristband is disclosed.

In U.S. Pat. No. 5,889,737, issued Mar. 30, 1999, and entitled “Wrist carried electronic device”, a wrist watch-type electronic apparatus with a computer or/and a radio circuitry, and two variants of a wristband is disclosed. The one wristband variant is a single, continuous wristband having the electrical energy storage device contained substantially throughout the wristband. The other wristband variant includes two wristband portions, wherein each wristband portion features an embedded flexible battery.

In U.S. Pat. No. 6,158,884, issued Dec. 12, 2000, and entitled “Integrated communicative watch”, a wrist watch-type electronic apparatus with a computer or/and radio circuitry, a flexible lithium-based battery embedded in one portion of the wristband fabricated of a textile material, and a means for inductive coupling with other electronic devices is disclosed. In addition, a mounting structure respectively attachment structure based on common pins or dowels for fastening the wristband or strap to the device case and simultaneously connecting the electronic components embedded in the wristband with the electronic circuitry housed inside the case of the wrist watch-type electronic apparatus is mentioned superficially.

In U.S. Pat. No. 8,467,270, issued Jun. 18, 2013, and entitled “Smart-watch with user interface features”, a wrist watch-type wearable computer with a base, a housing embedded within the base, a battery coupled to the housing, and modular links containing a function module therein is disclosed.

Other inventions already disclosed in this respect are related with wrist watch-type electronic devices that have different kinds of attachments for the wristbands and different kinds of mountings for a detachable body of the electronic unit. But a battery is not embedded within the wristband portions or/and is not mentioned as an auxiliary electronic component for extending the runtime of the devices.

In U.S. patent publication No. 2007/0064542, publicated Mar. 22, 2007, and entitled “Wristwatch type apparatus”, a wrist watch-type electronic apparatus with a mounting structure based on a quick-release plug-in mechanism for attaching the band respectively strap to the device case and simultaneously connecting the electric contact point at one end of the band with the electronic circuitry housed inside the case of the wrist watch-type electronic apparatus is disclosed.

In U.S. Pat. No. 3,492,809, issued Feb. 3, 1970, and entitled “Wrist watch movement and wristband combination”, an arrangement for mounting a wrist watch movement on a wristband, which avoids the appearance of any fastening means, such as lugs respectively horns and bows extending outwardly from the watchcase itself, is disclosed.

In U.S. Pat. No. 8,787,006, issued Jul. 22, 2014, and entitled “Wrist-worn electronic device and methods therefor”, an electronic wrist watch with an electronic wristband, which has a mechanism to removably couple a portable electronic device and also auxiliary electronic components to augment the functionality of the mobile electronic device, is disclosed.

However, it becomes appearent that many problems and also details of their proposed solutions with respect to the mechanically fastening, the electronically coupling, the wearing, the suitability, the strength, the durability, the design limits, and further aspects of the related straps, bands, or belts have not been addressed at all or have not been described in a detailed manner for these types of wrist-worn electronic devices in particular and for similar body-worn information processing devices respectively wearable computers in general. Furthermore, continuing demands and needs to improve functionalities of body-worn electronic devices have not been completely solved.

Accordingly, the present invention is directed to the mounting structures respectively attachment structures of the electronic strap, band, or belt to the central portion, body, housing, or case of a body-worn information processing device and the electronic strap, band, or belt itself, as well as the arrangements of the one or more electrical energy storage devices contained within the electronic strap, band, or belt, which are suitable for a wearable computer, provide a reasonable amount of electric power to operate its included electronic module or/and extend its runtime, substantially obviate one or more of the problems due to imperfections, limitations, and disadvantages of the related art, and do not adversely affect the aesthetic appearance.

### SUMMARY

In accordance with the purpose of the invention, as embodied and broadly described, the invention pertains to a body-worn information processing device respectively wearable computer that comprises a central portion, an electronic module including at least one processor and at least one data memory, an optional display, and at least one optional battery arranged within the central portion or a case according to the related variant, an electronic strap having at least one segment for wearing the device on a body part of a user, at least one electrical energy storage device or battery contained within the electronic strap, and a mounting structure or attachment structure for mechanically fastening the one or more segments of the electronic strap to the central portion and electronically coupling the one or more electrical energy storage devices contained within the strap to the electronic module contained within the central portion.

Several embodiments of the present invention provide different types of the mounting structure respectively attachment structure comprising a fastening means and a coupling means with conductive pins, wires routed through hollow barrels, and mating members, and also different types of joints comprising complementary form-locking shaped end sections of the electronic strap and side sections of the central portion, that are adapted from wrist watches and wrist-carried radiotelephones described above as prior art with the main differences that at least one battery contained within the electronic strap is coupled to an electronic module contained inside the central portion or case, but not an antenna or another electronic component. This includes the types of electrical coupling based on conductive coupling and inductive coupling, whereby the electric power transmission by inductive coupling is particularly advantageous for wearable computers that have to be waterproof.

In addition, the different types of the attachment structures can rigidly fix the electronic strap to the central portion or be constructed as a hinge to pivotably mount the strap to the central portion. Furthermore, owing to the features of many embodiments of the invention, it is not necessary to completely dismantle the central portion in order to exchange the electronic strap with the one or more electrical energy storage devices embedded therein. Moreover, the connection of at least one electrical energy storage device to the electronic module is reliable and durable overtime.

At least one electrical energy storage device contained within a portion of the electronic strap can consist of one or more solid or/and flexible battery cells that are connected by a plurality of electrically conductive members in a flexible or bendable, or/and elastic or stretchy way. Furthermore, by connecting small battery cells in parallel the temperature created by a high-power demand is distributed on the one hand and the battery life per charge can be extended on the other hand. A body-worn computing device with a battery contained within its central portion and with such an additional electrical energy storage device contained within a portion of its electronic strap provides a significantly longer runtime in comparison to a wearable computer, which has only a battery contained in its central portion or case.

In order to achieve the above and other objects, several embodiments of the present invention provide different types of the electronic strap, such as an electronic wristband, an electronic bracelet, or an electronic belt for example. Furthermore, a single segment of an electronic strap can be made of different kinds of materials, such as non-metallic materials and metallic materials. An ornamental material, such as leather or the like, is preferable for the outer layer member, whereby a high quality of appearance compared to that of wrist watchbands and body belts can be achieved. An electronic strap can also be padded for the reason(s) of comfort or/and aesthetics.

In further embodiments an electronic strap, an electronic bracelet, or an electronic belt can have a clasp means for removably securing the wearable computer on a body part of a user, wherein the clasp means can be of different types, such as a buckle, a buckle clasp with stud, a tang clasp, pin buckle, or buckle with tongue or prong, a ratchet buckle, a deployment clasp or fold-over clasp, a hook and loop fastener, or a releasably secure fastener to name just some preferred examples.

Some embodiments of the invention include a separate case for housing the electronic module, at least one additional electrical energy storage device, and the optional display, which together constitute a removable, independently useable, portable electronic device apart from the central portion and the electronic strap, and a central portion with a receptacle area or an opening configured to receive and electrically connect to this portable electronic device. The electronic strap is coupled to the central portion and suitable to assist with securing the central portion to a body part of a user and to provide additional electric energy to the received and connected portable electronic device arranged in the separate case.

In other embodiments a display, at least one additional electrical energy storage device, a means for wirelessly charging on the basis of inductive coupling, or/and a selective switching circuitry for controlling the electric power transmissions from and to the electrical energy storage devices are provided.

Through the combination of the different embodiments of the electronic strap, the one or more electrical energy storage devices, the attachment structure respectively the fastening means and coupling means, and the other optional electronic components, many different variants of the wearable computer can be constructed.

The invention may be implemented in numerous ways. Exemplary preferred embodiments of the present invention are wrist-worn electronic information processing devices with a display respectively smart-watches, that are discussed below, but not limited to such portable electronic devices and in this way applies to for example smart eyewear devices, head-mounted display devices, body belts, and also shoulder-worn wearable computers as well. In this conjunction, all the components or electronic units, which form the various parts of said smart-watches and which are known to those skilled in the art in the field of computer engineering, will not be described in detail. Only said components necessary to the elaboration of preferred embodiments of wearable computers according to the invention will be described.

Other systems, methods, features, advantages, objects, and further areas of applicability together with a more complete understanding of the disclosure will be, or will become, apparent and appreciated to one with skill in the art upon examination of the following figures and detailed description, or may be learned by practice of the present invention. It is intended that all such additional systems, methods, features, and advantages be included within this description, be within the scope of the present disclosure, and be protected by the following claims. Nothing in this section should be taken as a limitation on those claims. Further aspects and advantages are discussed below in conjunction with the embodiments. It is to be understood that both the foregoing general description and the following detailed description of the present disclosure are exemplary and explanatory and are intended to provide further explanation of the disclosure as claimed, but are not intended to limit the scope of the disclosure.

### BRIEF DESCRIPTION OF THE DRAWINGS

The accompanying drawings, which are included to provide a further understanding of the disclosure and are incorporated herein and constitute a part of this application, illustrate embodiment(s) of the disclosure and together with the description serve to explain the principle of the disclosure. In the drawings:

FIG. 1A illustrates a plan view of a wearable computer according to a first embodiment;

FIG. 1B illustrates a sectional plan view of the wearable computer illustrated in FIG. 1A;

FIG. 1C illustrates a sectional side view of the wearable computer taken along a line A-A in FIG. 1B;

FIG. 2A illustrates a plan view of a wearable computer according to a second embodiment;

FIG. 2B illustrates a sectional plan view of the wearable computer illustrated in FIG. 2A;

FIG. 2C illustrates a sectional side view of the wearable computer taken along a line B-B′ in FIG. 2B;

FIG. 3A illustrates a plan view of a wearable computer according to a third embodiment;

FIG. 3B illustrates a sectional plan view of the wearable computer illustrated in FIG. 3A;

FIG. 3C illustrates a sectional side view of the wearable computer taken along a line C-C′ in FIG. 3B;

FIG. 4A illustrates a plan view of a wearable computer according to a fourth embodiment;

FIG. 4B illustrates a sectional plan view of the wearable computer illustrated in FIG. 4A;

FIG. 4C illustrates a sectional side view of the wearable computer taken along a line D-D′ in FIG. 4B;

FIG. 5A illustrates a plan view of a wearable computer according to a fifth embodiment;

FIG. 5B illustrates a sectional plan view of the wearable computer illustrated in FIG. 5A;

FIG. 5C illustrates a sectional side view of the wearable computer taken along a line E-E′ in FIG. 5B;

FIG. 6A illustrates a plan view of a wearable computer according to a sixth embodiment;

FIG. 6B illustrates a sectional plan view of the wearable computer illustrated in FIG. 6A;

FIG. 6C illustrates a sectional side view of the wearable computer taken along a line F-F′ in FIG. 6B;

FIG. 7A illustrates a plan view of a wearable computer according to a seventh embodiment respectively modification of the first embodiment;

FIG. 7B illustrates a sectional side view of the wearable computer taken along a line G-G′ in FIG. 7A;

FIG. 7C illustrates a plan view of the wearable computer illustrated in FIG. 7A with the case removed from the central portion;

FIG. 7D illustrates a sectional side view of the wearable computer taken along a line G-G′ in FIG. 7A with the case removed from the central portion;

FIG. 8A illustrates a sectional plan view of a two part flexible, double-layer electronic strap with a tang clasp;

FIG. 8B illustrates a sectional side view of the electronic strap illustrated in FIG. 8A;

FIG. 8C illustrates a cross-sectional view of the electronic strap taken along a line H-H′ illustrated in FIGS. 8A and 8B;

FIG. 9A illustrates a sectional plan view of a two part flexible electronic strap with a tang clasp;

FIG. 9B illustrates a sectional side view of the electronic strap illustrated in FIG. 9A;

FIG. 9C illustrates a cross-sectional view of the electronic strap taken along a line I-I′ illustrated in FIGS. 9A and 9B;

FIG. 10A illustrates a sectional plan view of a two part flexible electronic strap with a tang clasp;

FIG. 10B illustrates a sectional side view of the electronic strap illustrated in FIG. 10A;

FIG. 11A illustrates a sectional plan view of a two part flexible and stretchable electronic strap with a tang clasp;

FIG. 11B illustrates a sectional side view of the electronic strap illustrated in FIG. 11A;

FIG. 12A illustrates a sectional plan view of a two part flexible electronic strap with a buckle and a wireless charging module;

FIG. 12B illustrates a sectional side view of the electronic strap illustrated in FIG. 12A;

FIG. 13A illustrates a sectional plan view of a two part flexible electronic strap with a buckle clasp with stud;

FIG. 13B illustrates a sectional side view of the electronic strap illustrated in FIG. 13A;

FIG. 14A illustrates a sectional plan view of a two part electronic strap with a clasp;

FIG. 14B illustrates a sectional side view of the electronic strap illustrated in FIG. 14A;

FIG. 15A illustrates a partially broken away, sectional plan view of a link arrangement of an electronic bracelet;

FIG. 15B illustrates a partially broken away, sectional plan view of a link arrangement of an electronic bracelet;

FIG. 15C illustrates a partially broken away, sectional plan view of a link arrangement of an electronic bracelet;

FIG. 16A illustrates a sectional side view of an electronic bracelet with an deployment clasp opened;

FIG. 16B illustrates a sectional side view of the electronic bracelet illustrated in FIG. 16A with the deployment clasp closed;

FIG. 17A illustrates a sectional side view of a flexible electronic strap with an hidden deployment clasp with single push button opened; and

FIG. 17B illustrates a sectional side view of the electronic strap illustrated in FIG. 17A with the hidden deployment clasp closed.

### DETAILED DESCRIPTION OF THE INVENTION

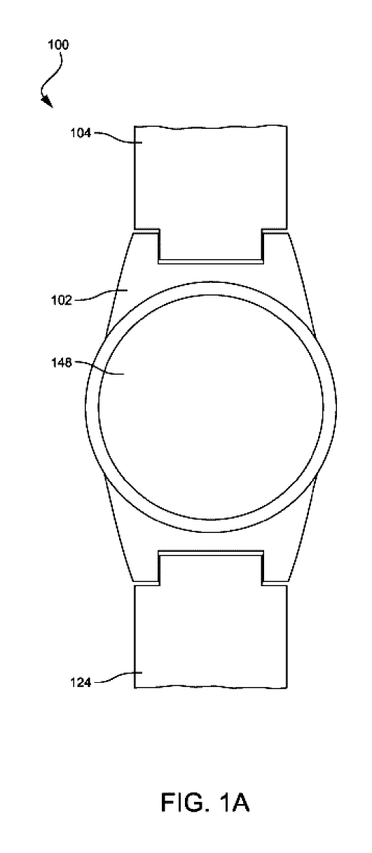

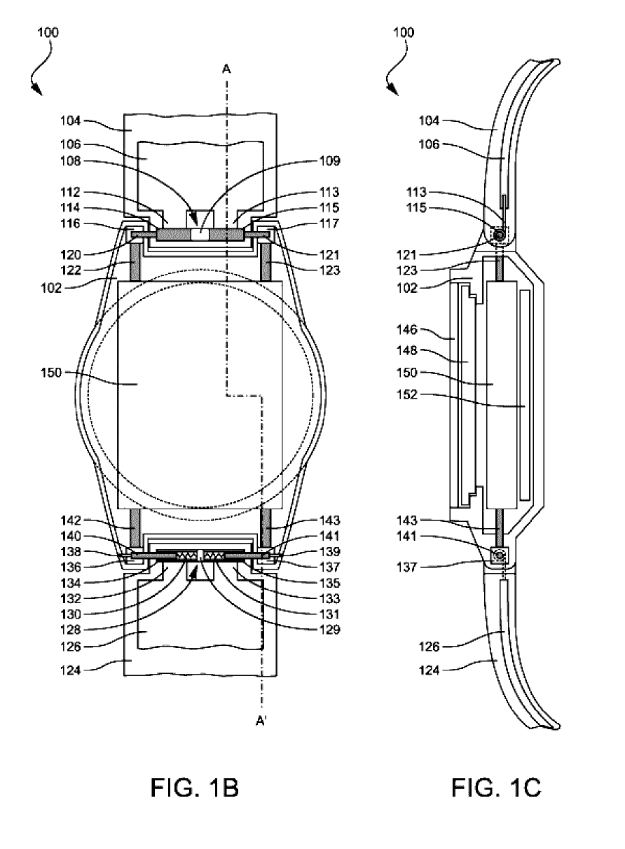

FIGS. 1A, 1B, and 1C schematically illustrate a first preferred embodiment of a wearable computing device 100. The wearable computer 100 comprises a central portion 102 for housing an optional display 148, an electronic module 150, and at least one optional battery 152 therein, a first strap portion 104 attached to a first side of the central portion 102, and a second strap portion 124 attached to a second side of the central portion 102 opposite the first side, as described hereinafter.

In the illustrated embodiment, shown in FIG. 1B, the central portion 102 contains a first pair of conductive, positive and negative insert elements 116, 117 and a second pair of conductive, positive and negative insert elements 136, 137. The insert elements are arranged within the lugs or horns of the central portion, insulated from each other and from the central portion, and electrically connected to at least one pair of conductive, positive and negative contacts of the electronic module 150 by the electrical conductors 122, 123 and 142, 143 respectively.

The first strap portion 104 contains a first energy storage device 106 and a first pair of cylindicral, conductive, positive and negative pins 108 consisting of the barrel sections 114, 115 and the conductive extension sections 120, 121, and the second strap portion 124 contains a second energy storage device 126 and a second pair of conductive, positive and negative pins 128 consisting of the barrel sections 134, 135 and the extension sections 140, 141 loaded by the springs 130, 131. The positive and negative contacts 112, 113 of the first energy storage device 106 are electrically connected to the barrel sections 114, 115 of the first pair of pins 108, and the positive and negative contacts 132, 133 of the second energy storage device 126 are electrically connected to the barrel sections 134, 135 of the second pair of pins 128. The electrically insulating element 109 between the barrel sections 114, 115, and the electrically insulating element 129 between the barrel sections 134, 135 avoid a short circuit between the contacts of the energy storage devices respectively the conductive pins.

By engaging the extension sections 120, 121 and the complementary insert elements 116, 117 the strap portion 104 is mechanically fastened and electrically coupled to the central portion 102. In the same way by engaging the extension sections 140, 141 and the complementary insert elements 136, 137 the strap portion 124 is mechanically fastened and electrically coupled to the central portion 102. As a result electric power can be transmitted between the electrical energy storage devices 106, 126, the electronic module 150, and other optional electronic components of the wearable computing device.

The fastening and coupling of the strap portion 104 and the strap portion 124 work in different ways. The strap portion 104 is attached by opening the central portion 102, inserting the related extension sections 120, 121 into the insert elements 116, 117, and closing the central portion again. The strap portion 104 is detached from the central portion in the reversed way. The strap portion 124 is removably attached by pushing the spring-loaded extension sections 140, 141 into the barrel sections 134, 135 and releasing them again for inserting the extension sections 140, 141 into the insert elements 136, 137. The strap portion 124 is detached from the central portion in the reversed way by pushing the extension sections 140, 141 through the holes 138, 139 in the central portion 102 with a suitable tool.

FIG. 1C shows the same configuration illustrated in FIG. 1B as a sectional side view taken along the line A-A shown in FIG. 1B. Therefore, the corresponding portions are denoted by the same reference numerals and the explanation is omitted with the exception that the display 148 is protected by a safety glass 146.

According to these attachments, the strap portion 104 can be removed from the central portion 102, and the strap portion 124 can be removed from the central portion by only pushing the spring-loaded extension sections 140, 141 into the barrel sections 134, 135 without separating another part of the central portion 102. Therefore, the strap portion 104 can be replaced and the strap portion 124 can be easily and rapidly replaced.

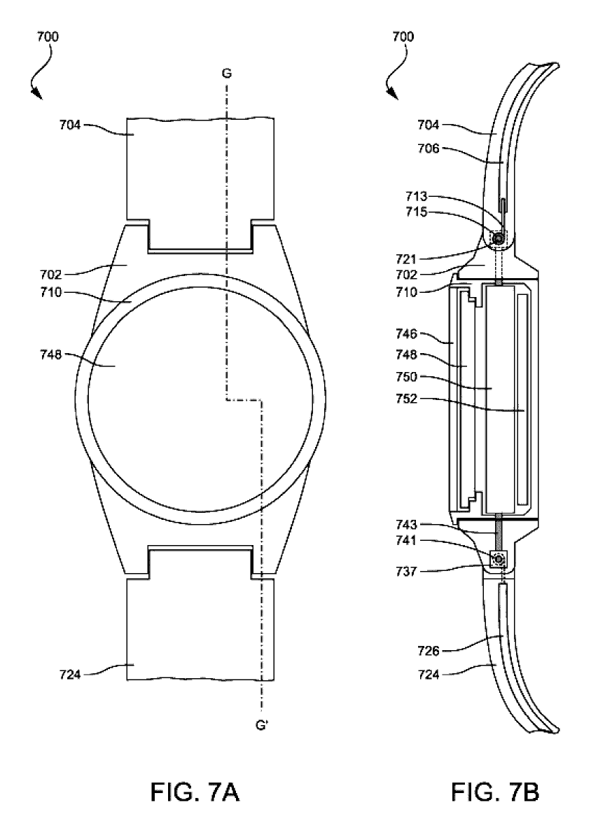

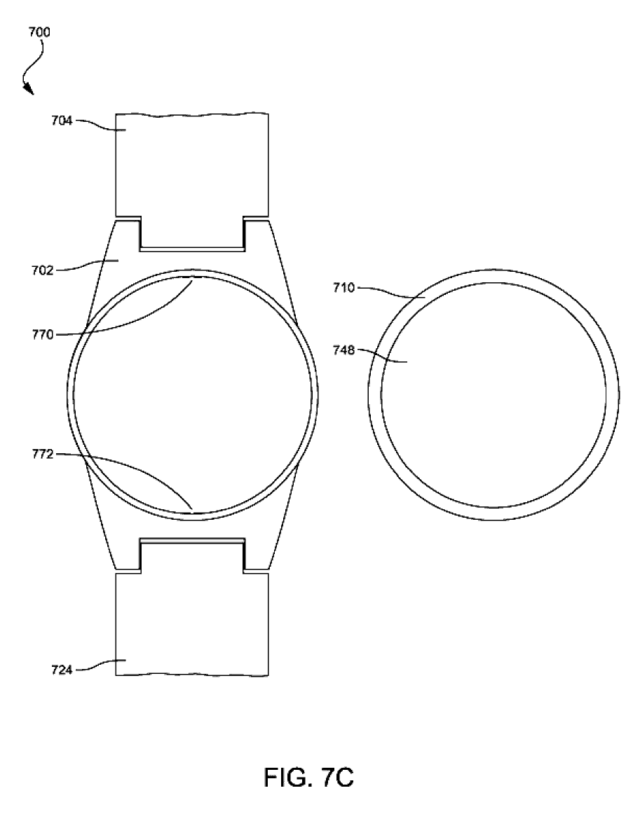

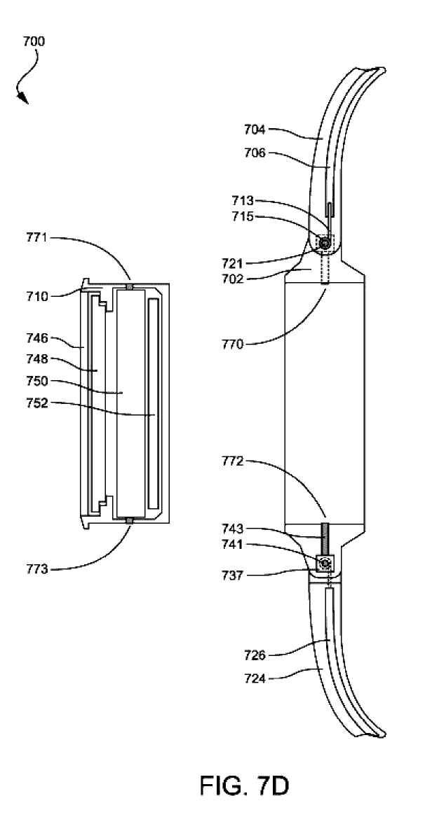

In modifications of the embodiment shown in FIGS. 1A, 1B, and 1C the central portion 102, the strap portions 104, 124, and the attachment structures may be formed and configured as hinges to pivotably fasten and couple the strap portions 104, 124 to the central portion 102. In addition, the FIGS. 7A, 7B, and 7C show an embodiment, which comprises the same attachment structure, but also a case housing the same electronic components, and a central portion having an opening configured to receive and electrically connect to said case.

Similar fastening and coupling structures are disclosed in U.S. Pat. No. 3,032,651, issued May 1, 1962, and entitled “Wrist carried radio set”, and U.S. Pat. No. 5,159,713, issued Oct. 27, 1992, and entitled “Watch pager and wrist antenna”, which are hereby incorporated herein by reference.

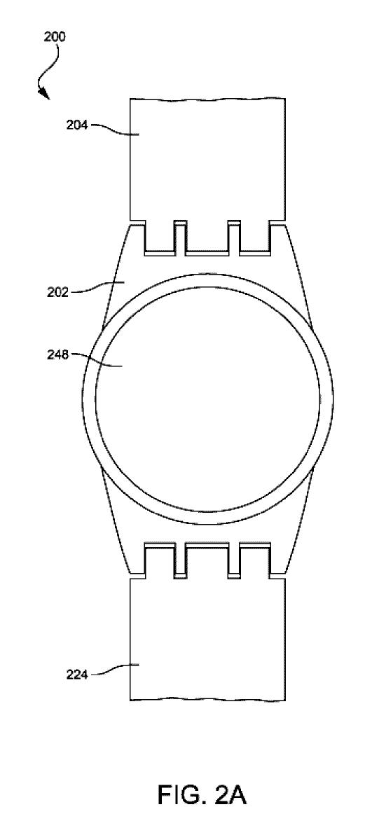

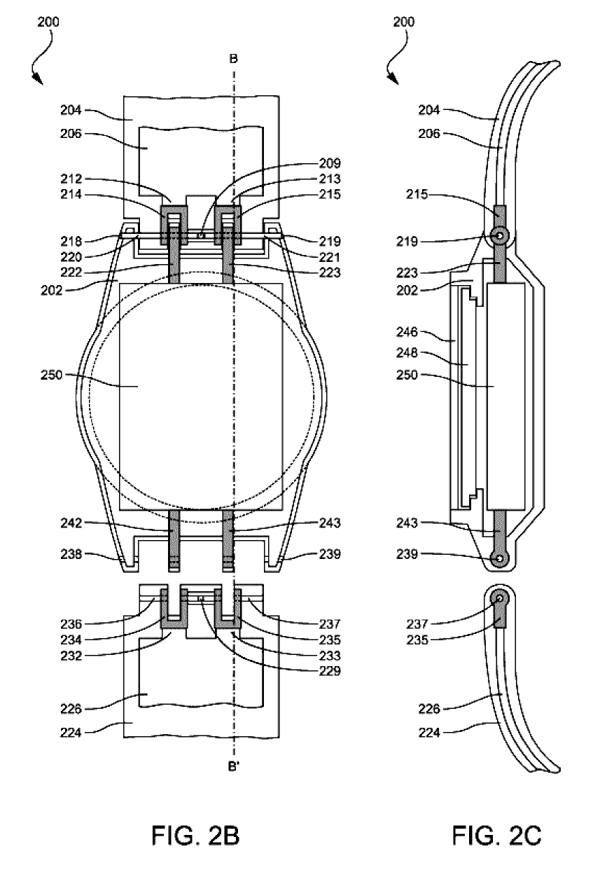

FIGS. 2A, 2B, and 2C schematically illustrate a second preferred embodiment of a wearable computing device 200. The wearable computer 200 comprises a central portion 202 for housing an optional display 248 and an electronic module 250 therein, a first strap portion 204 attached to a first side of the central portion 202, and a second strap portion 224 attached to a second side of the central portion 202 opposite the first side, as described hereinafter.

In the illustrated embodiment, shown in FIG. 2B, the central portion 202 contains a first pair of conductive, positive and negative mating members 222, 223 and a second pair of conductive, positive and negative mating members 242, 243. The mating members are arranged within the walls of the sockets sections of the central portion sides, insulated from each other and from the central portion, and electrically connected to at least one pair of conductive, positive and negative contacts of the electronic module 250.

The first strap portion 204 contains a first energy storage device 206 and a pair of conductive, positive and negative members 214, 215 arranged within the walls of the notches section of the end section of the strap portion, and the second strap portion 224 contains a second energy storage device 226 and a pair of conductive, positive and negative members 234, 235 arranged within the walls of the notches section of the end section of the strap portion. The positive and negative contacts 212, 213 of the first energy storage device 206 are electrically connected to the conductive members 214, 215, and the positive and negative contacts 232, 233 of the second energy storage device 226 are electrically connected to the conductive members 234, 235.

By putting the notches section of the end section of the strap portion 204 and the complementary form-locking shaped sockets section of the side section of the central portion 202 together the conductive members 214, 215 come into mechanical contact with the mating members 222, 223, and the strap portion 204 is mechanically fastened and electrically coupled to the central portion 202. In the same way by putting the notches section of the end section of the strap portion 224 and the complementary form-locking shaped sockets section of the side section of the central portion 202 together the conductive members 234, 235 come into mechanical contact with the mating members 242, 243, and the strap portion 224 is mechanically fastened and electrically coupled to the central portion 202.

For better clarity the illustrations show only the strap portion 204 being attached to the central portion 202, but not the strap portion 224. The strap portion 204 is secured to the case body 202 by the pins 220, 221 passing through the transverse openings 218, 219 in the central portion 202 and the related transverse openings in the strap portion 204. The strap portion 204 is detached from the central portion in the reversed way by pushing out the pins 220, 221 through the holes 218, 219 in the central portion 202 with a suitable tool. The strap portion 224 is secured in the same way after being put together with the sockets section of the central portion 202 by one or two pins inserted into the transverse openings 236, 238 and 237, 239. The electrically insulating element 209 between the conductive notch members 214, 215 and the electrically insulating element 229 between the conductive notch members 234, 235 avoid a short circuit between the contacts of the energy storage devices in the case that two conductive pins are used for securing a strap portion to the central portion. Alternatively, one or two non-conductive pins can be used for securing a strap portion to the central portion.

According to this attachment, the strap portions 204, 224 can be removed from the case body 202 by only pushing out the securing pins without separating another part of the central portion 202. Therefore, the strap portions can be easily and rapidly replaced.

FIG. 2C shows the same configuration illustrated in FIG. 2B as a sectional side view taken along the line B-B′ shown in FIG. 2B. Therefore, the corresponding portions are denoted by the same reference numerals and the explanation is omitted with the exception that the display 248 is protected by a safety glass 246.

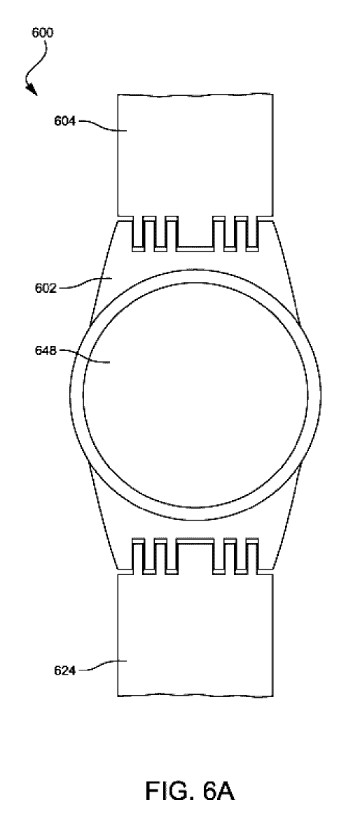

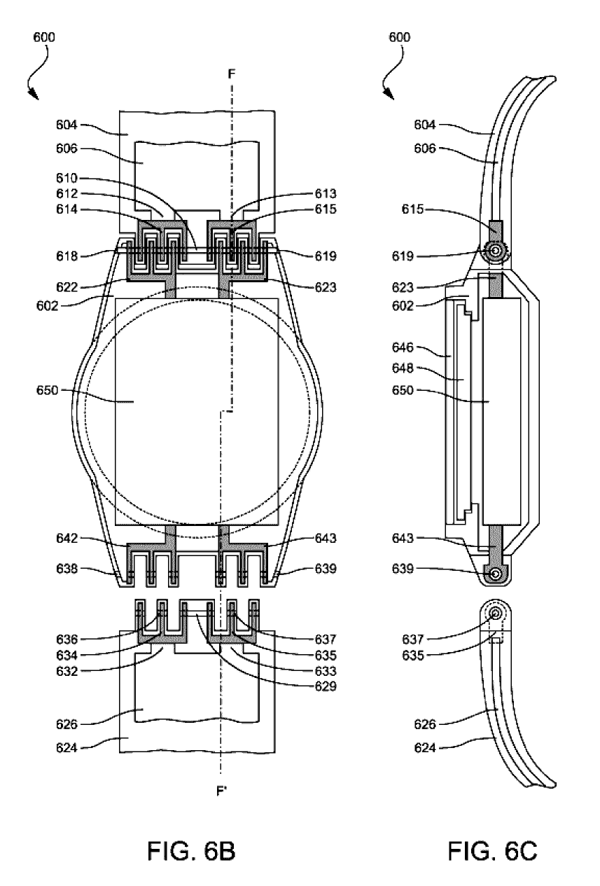

In modifications of the embodiment shown in FIGS. 2A, 2B, and 2C the central portion 202, the strap portions 204, 224, and the attachment structures may be formed with a different number of notches and complementary sockets, or/and with a different shape for the notches and complementary sockets. In addition, the central portion 202, the strap portions 204, 224, and the attachment structures may be formed and configured as hinges to pivotably fasten and couple the strap portions 204, 224 to the central portion 202, or/and may be configured as inductive coupling means as discussed in FIGS. 6A, 6B, and 6C.

A similar fastening and coupling structure is disclosed in U.S. Pat. No. 6,590,835, issued Jul. 8, 2003, and entitled “Portable object with a wristband including a keyboard”, which is hereby incorporated herein by reference.

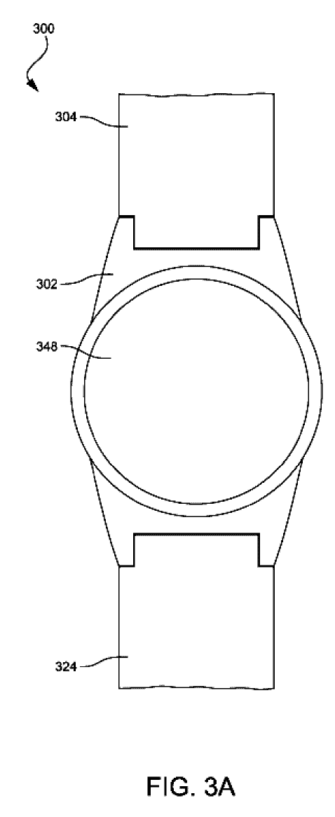

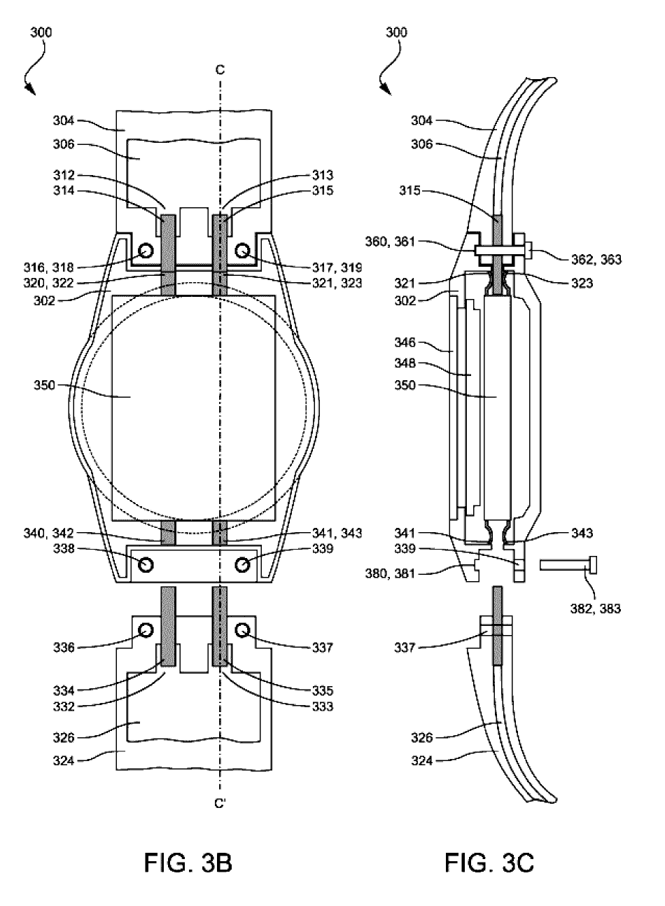

FIGS. 3A, 3B, and 3C schematically illustrate a third preferred embodiment of a wearable computing device 300. The wearable computer 300 comprises a central portion 302 for housing an optional display 348 and an electronic module 350 therein, a first strap portion 304 attached to a first side of the central portion 302, and a second strap portion 324 attached to a second side of the central portion 302 opposite the first side, as described hereinafter.

In the illustrated embodiment, shown in FIG. 3B, the central portion 302 contains a first pair of conductive, positive mating members 320, 322, a first pair of conductive, negative mating members 321, 323, a second pair of conductive, positive mating members 340, 342, and a second pair of conductive, negative mating members 341, 343. The mating members are arranged within the central portion, insulated from each other and from the central portion, and electrically connected to at least one pair of conductive, positive and negative contacts of the electronic module 350.

The first strap portion 304 contains a first energy storage device 306 and a pair of conductive, positive and negative members 314, 315 arranged within the walls of the key section of the end section of the strap portion, and the second strap portion 324 contains a second energy storage device 326 and a pair of conductive, positive and negative members 334, 335 arranged within the walls of the key section of the end section of the strap portion. The positive and negative contacts 312, 313 of the first energy storage device 306 are electrically connected to the conductive members 314, 315, and the positive and negative contacts 332, 333 of the second energy storage device 326 are electrically connected to the conductive members 334, 335.

By plugging the key section of the end section of the strap portion 304 into the complementary form-locking shaped slot section of the side section of the central portion 302 the conductive members 314, 315 come into mechanical contact with the mating members 320, 322 and 321, 323, and the strap portion 304 is mechanically fastened and electrically coupled to the central portion 302. In the same way by plugging the key section of the end section of the strap portion 324 in the complementary form-locking shaped slot section of the side section of the central portion 302 the conductive members 334, 335 come into mechanical contact with the mating members 340, 342 and 341, 343, and the strap portion 324 is mechanically fastened and electrically coupled to the central portion 302.

For better clarity the illustrations show only the strap portion 304 being attached to the central portion 302, but not the strap portion 324. The strap portion 304 is fixed to the central portion 302 with the fixing screw 363, which is passed through the holes 317 and 319 and fastened in the screw hole 361 in the central portion 302. Likewise but also not shown in the illustrations for better clarity, fixing screw 362 is passed through the holes 316 and 318 and fastened in the screw hole 360. The strap portion 304 is detached from the central portion in the reversed way by unscrewing the screws 362, 363 and removing them out of the holes in the central portion 302 with a suitable tool. The strap portion 324 is secured in the same way after being plugged into the slot section of the central portion 302 with the fixing screws 382, 383, which are passed through the holes 336, 338 and 337, 339, and fastened in the screw holes 380, 381 in the central portion 302.

FIG. 3C shows the same configuration illustrated in FIG. 3B as a sectional side view taken along the line C-C′ shown in FIG. 3B. Therefore, the corresponding portions are denoted by the same reference numerals and the explanation is omitted with the exception that the display 348 is protected by a safety glass 346.

According to this attachment, the strap portions 304, 324 can be removed from the central portion 302 by only removing the screws 362, 363 and 382, 383 without separating another part of the central portion 302. Therefore, the strap portions can be easily and rapidly replaced.

In modifications of the embodiment shown in FIGS. 3A, 3B, and 3C the end sections of the strap portions 304, 324 may be formed and configured as hinges to pivotably fasten and couple the strap portions 304, 324 to the central portion 302 by integrating one of the various embodiments as discussed in FIGS. 1A, 1B, and 1C, 2A, 2B, and 2C, 4A, 4B, and 4C, 5A, 5B, and 5C, 6A, 6B, and 6C, and 7A, 7B, 7C, and 7D, or/and may be configured as inductive coupling means as discussed in FIGS. 6A, 6B, and 6C.

Similar fastening and coupling structures are disclosed in U.S. Pat. No. 5,742,256, issued Apr. 21, 1998, and entitled “Wristband having embedded electrically conductive members for a wrist-mountable type electronic device”, and U.S. Pat. No. 6,619,835, issued Sep. 16, 2003, and entitled “Body wearable information processing terminal device”, which are hereby incorporated herein by reference.

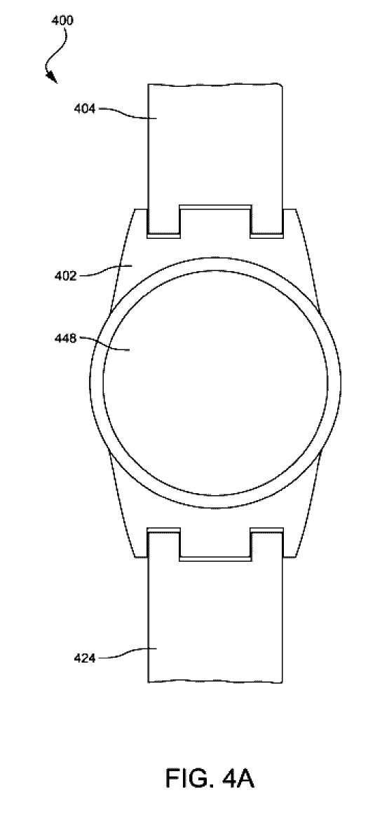

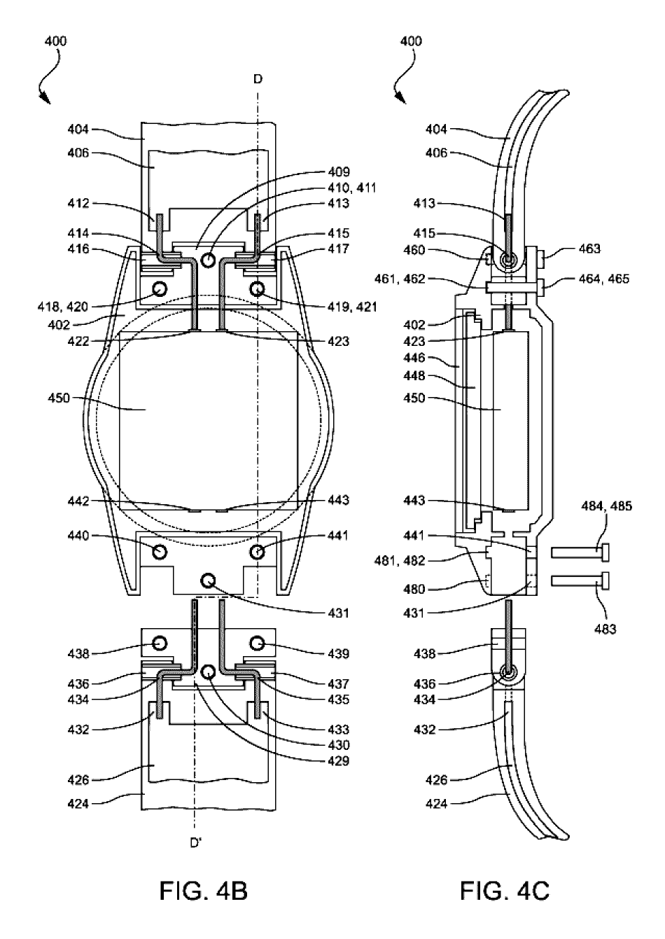

FIGS. 4A, 4B, and 4C schematically illustrate a fourth preferred embodiment of a wearable computing device 400. The wearable computer 400 comprises a central portion 402 for housing an optional display 448 and an electronic module 450 therein, a first strap portion 404 attached to a first side of the central portion 402, and a second strap portion 424 attached to a second side of the central portion 402 opposite the first side, as described hereinafter.

In the illustrated embodiment, shown in FIG. 4B, the central portion 402 contains a first pair of conductive, positive and negative mating members 422, 423, and a second pair of conductive, positive and negative mating members 442, 443. The mating members are arranged within the central portion, insulated from each other and from the central portion, and electrically connected to at least one pair of conductive, positive and negative contacts of the electronic module 450.

The strap portion 404 and the key shaped end section of the base section 409 are connected by the pair of hollow barrels 416, 417, and the strap portion 424 and the key shaped end section of the base section 429 are connected by the pair of hollow barrels 436, 437 for pivotably fastening and coupling the strap portions 404, 424 to the central portion 402.

The first strap portion 404 contains a first energy storage device 406 and the second strap portion 424 contains a second energy storage device 426. The positive and negative contacts 412, 413 of the first energy storage device 406 are electrically connected to a first pair of conductive, insulated wires 414, 415, and the positive and negative contacts 432, 433 of the second energy storage device 426 are electrically connected to a second pair of conductive, insulated wires 434, 435. The wire 414 is passed through the hollow barrel 416, the wire 415 is passed through the hollow barrel 417, the wire 434 is passed through the hollow barrel 436, and the wire 435 is passed through the hollow barrel 437.

By plugging the base section 409 of the strap portion 404 into the complementary form-locking shaped slot section of the side section of the central portion 402 the conductive wires 414, 415 come into mechanical contact with the mating members 422, 423, and the strap portion 404 is mechanically fastened and electrically coupled to the central portion 402. In the same way by plugging the base section 429 of the strap portion 424 into the complementary form-locking shaped slot section of the side section of the central portion 402 the conductive wires 434, 435 come into mechanical contact with the mating members 442, 444, and the strap portion 424 is mechanically fastened and electrically coupled to the central portion 402.

For better clarity the illustrations show only the strap portion 404 being attached to the central portion 402, but not the strap portion 424. The strap portion 404 is fixed to the central portion 402 with the fixing screw 463, which is passed through the holes 410 and 411 and fastened in the screw hole 460 in the central portion 402, and the fixing screw 465, which is passed through the holes 419 and 421 and fastened in the screw hole 461 in the central portion 402. Likewise but also not shown in the illustrations for better clarity, fixing screw 464 is passed through the holes 418 and 420 and fastened in the screw hole 462. The strap portion 404 is detached from the central portion in the reversed way by unscrewing the screws 463, 464, and 465, and removing them out of the holes in the central portion 402 with a suitable tool. The strap portion 424 is secured in the same way after being plugged into the slot section of the central portion 402 with the fixing screws 483, 484, and 485, which are passed through the holes 430, 431, 438, 440, and 439, 441, and fastened in the screw holes 480, 481, and 482 in the central portion 402.

FIG. 4C shows the same configuration illustrated in FIG. 4B as a sectional side view taken along the line D-D′ shown in FIG. 4B. Therefore, the corresponding portions are denoted by the same reference numerals and the explanation is omitted with the exception that the display 448 is protected by a safety glass 446.

According to this attachment, the strap portions 404, 424 can be removed from the central portion 402 by only removing the screws 463, 464, and 465, and 483, 484, and 485 without separating another part of the central portion 402. Therefore, the strap portions can be easily and rapidly replaced.

In modifications of the embodiment shown in FIGS. 4A, 4B, and 4C the central portion 402, the strap portions 404, 424, and the attachment structures may be formed and configured as hinges to pivotably fasten and couple the strap portions 404, 424 to the central portion 402 by integrating the embodiment discussed in FIGS. 1A, 1B, and 1C with the base sections 409, 429 removed, and the pair of pins 108 and the complementary insert elements 116, 117 substituted by the pair of hollow barrels 416, 417, and the pair of pins 128 and the complementary insert elements 136, 137 substituted by the pair of hollow barrels 436, 437 with pairs of hollow barrels 416, 417 and 436, 437 connected to the lugs of the central portion 402.

A similar mounting structure is disclosed in U.S. Pat. No. 5,615,179, issued Mar. 25, 1997, and entitled “Electronic apparatus with fitting band”, which is hereby incorporated herein by reference.

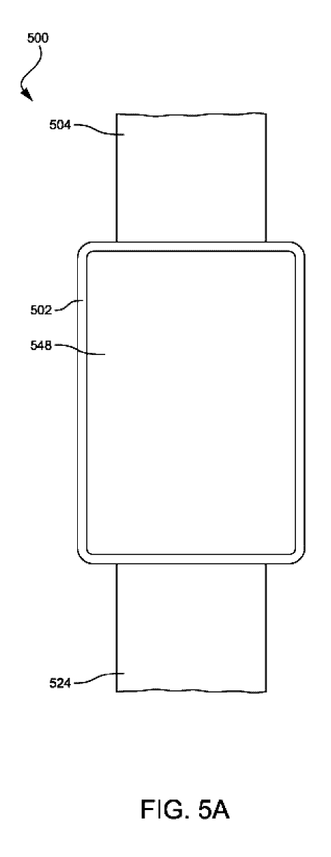

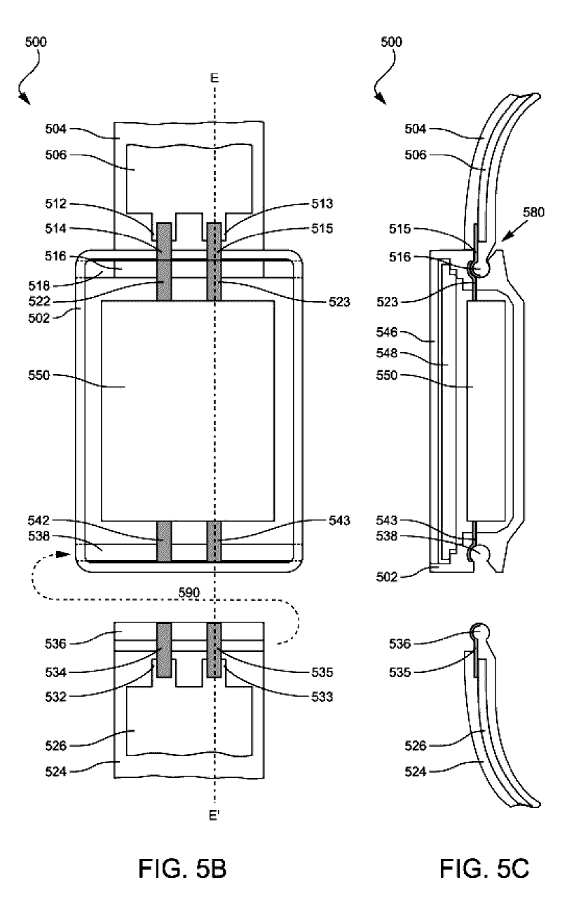

FIGS. 5A, 5B, and 5C schematically illustrate a fifth preferred embodiment of a wearable computing device 500. The wearable computer 500 comprises a central portion 502 for housing an optional display 548 and an electronic module 550 therein, a first strap portion 504 attached to a first side of the central portion 502, and a second strap portion 524 attached to a second side of the central portion 502 opposite the first side, as described hereinafter.

In the illustrated embodiment, shown in FIG. 5B, the central portion 502 contains a first pair of conductive, positive and negative mating members 522, 523 and a second pair of conductive, positive and negative mating members 542, 543. The mating members are arranged within the central portion, insulated from each other and from the central portion, and electrically connected to at least one pair of conductive, positive and negative contacts of the electronic module 550.

The first strap portion 504 contains a first energy storage device 506 and a pair of conductive, positive and negative members 514, 515 arranged within the wall of the tongue section 516 of the end section of the strap portion, and the second strap portion 524 contains a second energy storage device 526 and a pair of conductive, positive and negative members 534, 535 arranged within the wall of the tongue section 536 of the end section of the strap portion. The positive and negative contacts 512, 513 of the first energy storage device 506 are electrically connected to the conductive members 514, 515, and the positive and negative contacts 532, 533 of the second energy storage device 526 are electrically connected to the conductive members 534, 535.

By sliding the tongue section 516 of the end section of the strap portion 504 in the complementary form-locking shaped groove section 518 of the side section of the central portion 502 the conductive members 514, 515 come into mechanical contact with the mating members 522, 523, and the strap portion 504 is mechanically fastened and electrically coupled to the central portion 502. In the same way, by sliding the tongue section 536 of the end section of the strap portion 524 in the complementary form-locking shaped groove section 538 of the side section of the central portion 502 following the path 590 in the direction indicated by the arrow the conductive members 534, 535 come into mechanical contact with the mating members 542, 543, and the strap portion 524 is mechanically fastened and electrically coupled to the central portion 502.

For better clarity the illustrations show only the strap portion 504 being attached to the central portion 502, but not the strap portion 524.

According to this attachment, the strap portions 504, 524 can be removed from the case body 502 by only sliding the strap portions out of the grooves 516, 536 without separating another part of the central portion 502. Therefore, the strap portions can be easily and rapidly replaced.

FIG. 5C shows the same configuration illustrated in FIG. 5B as a sectional side view taken along the line E-E′ shown in FIG. 5B. Therefore, the corresponding portions are denoted by the same reference numerals and the explanation is omitted with the exceptions that the strap portion 504 is formed with a bevel 580 at its lower side to be pivotably fastened and coupled to the central portion 502 in contrast to the strap portion 524, which is formed to be rigidly fastened and coupled to the central portion 502, and the display 548 is protected by a safety glass 546.

FIGS. 6A, 6B, and 6C schematically illustrate a sixth preferred embodiment of a wearable computing device 600, which is constructed in the same way like the embodiment illustrated in FIGS. 2A, 2B, and 2C, but differs in the way that electric power is transmitted from the electrical energy storage devices 606, 626 to the electronic module 650 by an inductive coupling means.

The wearable computer 600 comprises a central portion 602 for housing an optional display 648 and an electronic module 650 therein, a first strap portion 604 attached to a first side of the central portion 602, and a second strap portion 624 attached to a second side of the central portion 602 opposite the first side, as described hereinafter.

In the illustrated embodiment, shown in FIG. 6B, the central portion 602 contains a first pair of conductive, positive and negative mating members 622, 623 and a second pair of conductive, positive and negative mating members 642, 643. The mating members are arranged within the walls of the sockets sections of the central portion sides, insulated from each other and from the central portion, and electrically connected to at least one pair of conductive, positive and negative contacts of the electronic module 650.

The first strap portion 604 contains a first energy storage device 606 and a pair of conductive, positive and negative members 614, 615 arranged within the notches section of the strap portion end, and the second strap portion 624 contains a second energy storage device 626 and a pair of conductive, positive and negative members 634, 635 arranged within the notches section of the end section of the strap portion end. The positive and negative contacts 612, 613 of the first energy storage device 606 are electrically connected to the conductive members 614, 615, and the positive and negative contacts 632, 633 of the second energy storage device 626 are electrically connected to the conductive members 634, 635.

By putting the notches section of the end section of the strap portion 604 and the complementary form-locking shaped sockets section of the side section of the central portion 602 together the conductive members 614, 615 come together with the mating members 622, 623 without mechanical contact, and the strap portion 604 is mechanically fastened and inductively coupled to the central portion 602. In the same way, by putting the notches section of the end section of the strap portion 624 and the complementary form-locking shaped sockets section of the side section of the central portion 602 together the conductive members 634, 635 come together with the mating members 642, 643 without mechanical contact, and the strap portion 624 is mechanically fastened and inductively coupled to the central portion 602.

By using more notches and sockets with larger conductive members 614, 615 and 634, 635, and corresponding mating members 622, 623 and 642, 643 in comparison to the members 214, 215 and 234, 235, and the corresponding mating members 222, 223 and 242, 243 shown in FIGS. 2B and 2C the effective area of the inductive coupling means is increased and accordingly the performance of the electric power transmission by inductive coupling is improved.

For better clarity the illustrations show only the strap portion 604 being attached to the central portion 602, but not the strap portion 624. The strap portion 604 is secured to the case body 602 by the pin 610 passing through the transverse openings 618, 619 in the central portion 602 and the related transverse openings in the strap portion 604. The strap portion 604 is detached from the central portion in the reversed way by pushing out the pin 610 through the holes 618, 619 in the central portion 602 with a suitable tool. The strap portion 624 is secured in the same way after being put into the sockets section of the central portion 602 by one pin inserted into the transverse openings 636, 638 and 637, 639. An electrically insulating element between the conductive notch members 614, 615 and 634, 635 is not needed to avoid a short circuit between the contacts of the energy storage devices in the case that a conductive pin is used for securing a strap portion to the central portion, because the pins do not come in mechanical contact with the conductive members 614, 615 and 634, 635, and corresponding mating members 622, 623 and 642, 643 arranged within the notches sections and sockets sections.

According to this attachment, the strap portions 604, 624 can be removed from the case body 602 by only pushing out the securing pins without separating another part of the central portion 602. Therefore, the strap portions can be easily and rapidly replaced. Furthermore, by transmitting electric power by an inductive coupling means the wearable computer can be made waterproof respectively used in wet environments, because the energy storage devices cannot come in contact with the wet environment and in this way a short circuit between the contacts is not possible.

In modifications of the embodiment shown in FIGS. 6A, 6B, and 6C the central portion 602, the strap portions 604, 624, and the attachment structures may be formed with a different number of notches and complementary sockets, or/and with a different shape for the notches and complementary sockets. In addition, the central portion 602, the strap portions 604, 624, and the attachment structures may be formed and configured as hinges to pivotably fasten and couple the strap portions 604, 624 to the central portion 602.

FIG. 6C shows the same configuration illustrated in FIG. 6B as a sectional side view taken along the line F-F′ shown in FIG. 6B. Therefore, the corresponding portions are denoted by the same reference numerals and the explanation is omitted with the exception that the display 648 is protected by a safety glass 646.

FIGS. 7A, 7B, 7C, and 7D schematically illustrate a seventh preferred embodiment of a wearable computing device 700, which comprises the attachment structure and connection structure of the embodiment illustrated in FIGS. 1A, 1B, and 1C, but differs in the way that the wearable computer 700 comprises a removable case 710 for housing an optional display 748, an electronic module 750, at least one electrical energy storage device 752, and pairs of conductive, positive and negative contacts configured as electrical connectors 771, 773, and electrically connected to at least one pair of conductive, positive and negative contacts of the electronic module 750 therein. The wearable computer 700 further comprises a central portion 702 for mechanically and electrically connecting to the removable case 710, a first strap portion 704 attached to a first side of the central portion 702, and a second strap portion 724 attached to a second side of the central portion 702 opposite the first side. The removable case 710 together with the contained electronic components constitute a portable electronic device, which can be used independently when detached from the central portion 702 as shown in FIGS. 7C and 7D.

In the illustrated embodiment, shown in FIGS. 7C and 7D, the central portion 702 contains a pair of conductive, pairs of positive and negative contacts configured as electrical connectors 770, 772, and electrically connected to at least one pair of conductive, negative and positive insert elements being arranged within the central portion 702 as discussed in relation with the same attachment structure shown in FIGS. 1A, 1B, and 1C. The connectors are provided at the receptacle area respectively opening molded in the central portion, insulated from each other and from the central portion, and used at least in part to removably secure the case 710 to the receptacle area of the central portion 702, so that the electronic module 750 housed in the case 710 is electrically connected to the energy storage devices 706, 726 contained in the strap portions 704, 706 via the electrical connectors 771, 773 and 770, 772, and supplied with electric power.

Because the structures of the strap portions 704 containing a first energy storage device 706, the second strap portion 724 containing a second energy storage device 726, and the attachment structure respectively fastening means and coupling means for mechanically fastening and electrically coupling the strap portions 704, 724 to the central portion 702, and the connection structures for electrically connecting the attachment structures to the electronic module 750 within the central portion 702 are the attachment and connection structures of the embodiment illustrated in FIGS. 1A, 1B, and 1C, the detailed illustration and discussion of the first pair of conductive, positive and negative pins 708 consisting of the barrel sections 714, 715 and the conductive extension sections 720, 721, the second pair of conductive, positive and negative pins 728 consisting of the barrel sections 734, 735 and the extension sections 740, 741 loaded by the springs 730, 731, the positive and negative contacts 712, 713 and 732, 733 of the electrical energy storage devices 706, 726, the electrically insulating elements 709, 729 between the barrel sections 714, 715 and 734, 735, and the complementary insert elements 716, 717 and 736, 737 arranged within the central portion 702, and also the way of fastening and coupling the strap portions 704, 724 to the central portion 702 are partly omitted, and instead it is referred to the detailed illustration and discussion of FIGS. 1A, 1B, and 1C.

FIGS. 7A and 7B show the wearable computer 700 with the case 710 inserted in the opening of the central portion 702, and FIGS. 7C and 7D show the same configuration illustrated in FIGS. 7A and 7B with the case 710 taken out of the opening of the central portion 702. Furthermore, FIGS. 7B and 7D show the same configuration illustrated in FIG. 7A as a sectional side view taken along the line G-G′ shown in FIG. 7A. Therefore, the corresponding portions are denoted by the same reference numerals and the explanation is omitted with the exception that the display 748 is protected by a safety glass 746.

A similar electronic device is disclosed in U.S. Pat. No. 8,787,006, issued Jul. 22, 2014, and entitled “Wrist-worn electronic device and methods therefor”, and a similar wristband construction is disclosed in U.S. Pat. No. 3,492,809, issued Feb. 3, 1970, and entitled “Wrist watch movement and wristband combination”, which are hereby incorporated herein by reference.

Not shown with the various embodiments illustrated in FIGS. 1A, 1B, and 1C to 6A, 6B, and 6C, and 7A, 7B, 7C, and 7D are looking means for the various attachment structures, such as a pin or screw, for keeping a strap in the right position, or/and securing a strap from being unintentionally detached from a central portion of a wearable computer. Also not shown in FIGS. 1A, 1B, and 1C to 6A, 6B, and 6C, and 7A, 7B, 7C, and 7D are sealing means for the various attachment structures for avoiding that electronic components contained with an electronic strap and a central portion, such as conductive pins and mating members for example, come in contact with a fluid such as water for example and create a short circuit between the contacts of the energy storage devices and other the conductive conductors or/and damage electronic components in other ways.

Furthermore, it is understood that the two strap portions shown in FIGS. 1A, 1B, and 1C to 6A, 6B, and 6C, and 7A, 7B, 7C, and 7D may be segments of a single, continuous strap or a two part strap with a clasp means. Correspondingly, the shown portions of the electrical energy storage devices may be segments of a single, continuous electrical energy storage device contained within a single, continuous strap, or a segment of a first electrical energy storage device and a segment of a second electrical energy storage device in the case of a two part strap.

In addition and without any intention to limit the scope of the disclosure, in the various embodiments illustrated in FIGS. 1A, 1B, and 1C to 6A, 6B, and 6C, and 7A, 7B, 7C, and 7D the portions of the electrical energy storage devices are of the type solid or flexible thin film batteries.

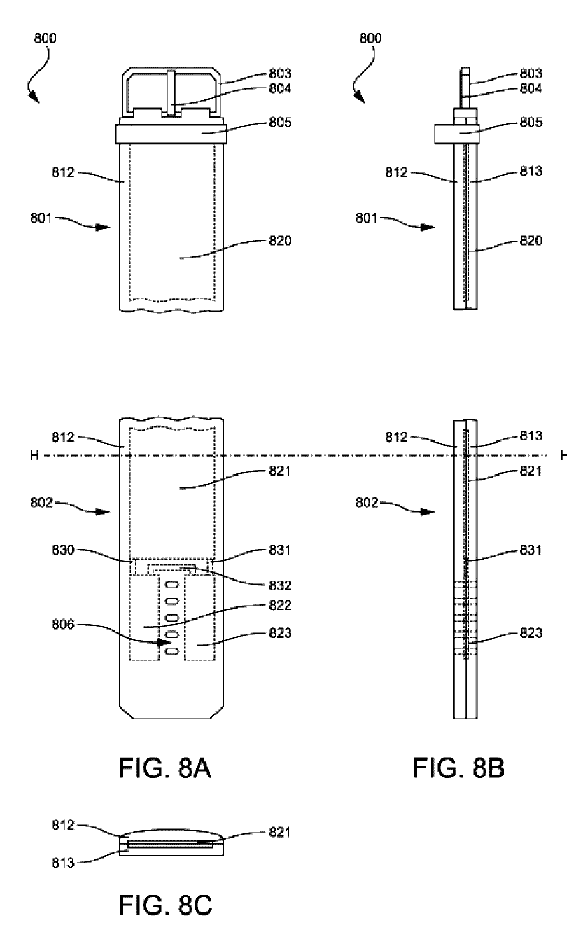

In various embodiments of the invention the various embodiments of the attachment structure illustrated, discussed, and suggested in FIGS. 1A, 1B, and 1C to 6A, 6B, and 6C, and 7A, 7B, 7C, and 7D can be used in accordance with the various embodiments of the strap illustrated, discussed, and suggested below in FIGS. 8A, 8B, and 8C, 9A, 9B, and 9C, 10A and 10B to 14A and 14B, 15A, 15B, and 15C, 16A and 16B, and 17A and 17B.

FIGS. 8A, 8B, and 8C schematically illustrate a preferred embodiment of a two part flexible, double-layer electronic strap 800. The electronic strap comprises a first double-layer strap portion 801 with a tang clasp, which has a buckle 803 and a center fastening pin, tongue, or pronge 804, and a strap fastening loop member 805, and is attached to an end of the strap portion 801, and a second double-layer strap portion 802 with a row of holes 806 inserted in an end of the strap portion 802. For fastening a wearable computer, which is arranged between the other ends of the strap portions 801, 802, on a body part of a user the end of the strap portion 802 is inserted through the buckle 803 at first, then the pin 804 is inserted in one of the holes 806, and finally the end of the strap portion 802 is inserted through the fastening loop member 805.

The flexible, double-layer strap portions 801, 802 are made of an outer layer member 812 being made of a first flexible material, and an inner layer member 813 being made of a second flexible material for contact with a body part of a user.

The flexible, double-layer strap portion 801 is sandwiching a substantially flat and flexible electrical energy storage device 820, and the strap portion 802 is sandwiching substantially flat and flexible electrical energy storage devices 821, 822, and 823 between the outer and inner layer members 812 and 813. The electrical energy storage device 821 is electrically connected to the electrical energy storage device 822 by a conductive member 830, and with the electrical energy storage device 823 by a conductive member 831, and the electrical energy storage devices 822 and 823 are electrically connected to each other by a conductive member 832 in a flexible way.

FIG. 8B shows the same configuration illustrated in FIG. 8A as a sectional side view, and FIG. 8C shows the same configuration illustrated in FIGS. 8A and 8B as a cross-sectional side view taken along the line H-H′ shown in FIGS. 8A and 8B. Therefore, the corresponding portions are denoted by the same reference numerals and the explanation is omitted.

Similar flexible, double-layer electronic straps are disclosed in U.S. Pat. No. 5,615,179, issued Mar. 25, 1997, and entitled “Electronic apparatus with fitting band”, which is already incorporated herein by reference.

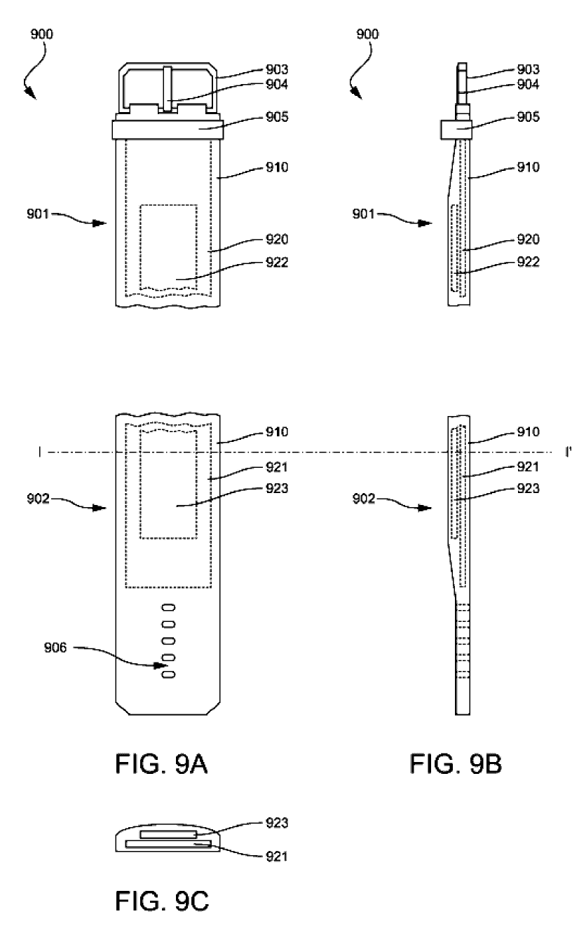

FIGS. 9A, 9B, and 9C schematically illustrate an other preferred embodiment of a two part flexible electronic strap 900. The electronic strap comprises a first strap portion 901 with a tang clasp, which has a buckle 903 and a center fastening pin, tongue, or pronge 904, and a strap fastening loop member 905, and is attached to an end of the strap portion 901, and a second strap portion 902 with a row of holes 906 inserted in an end of the strap portion 902. For fastening a wearable computer, which is arranged between the other ends of the strap portions 901, 902, on a body part of a user the end of the strap portion 902 is inserted through the buckle 903 at first, then the pin 904 is inserted in one of the holes 906, and finally the end of the strap portion 902 is inserted through the strap fastening loop member 905.

The strap portions 901, 902 are made of a flexible material 910 for contact with a body part of a user.

The strap portion 901 is embedding substantially flat and flexible electrical energy storage devices 920 and 922 stacked on each other, and the strap portion 902 is embedding substantially flat and flexible electrical energy storage devices 921 and 923 stacked on each other. Not shown in the illustration for better clarity, the stacked electrical energy storage devices 920 and 922, and 921 and 923 are electrically connected by conductive members in a flexible way.

With such a configuration of stacked electrical energy storage devices 920 and 922, and 921 and 923 embedded within the strap portions 901, 902 the runtime of a wearable computer can be increased a further time.

FIG. 9B shows the same configuration illustrated in FIG. 9A as a sectional side view, and FIG. 9C shows the same configuration illustrated in FIGS. 9A and 9B as a cross-sectional side view taken along the line I-I′ shown in FIGS. 9A and 9B. Therefore, the corresponding portions are denoted by the same reference numerals and the explanation is omitted.

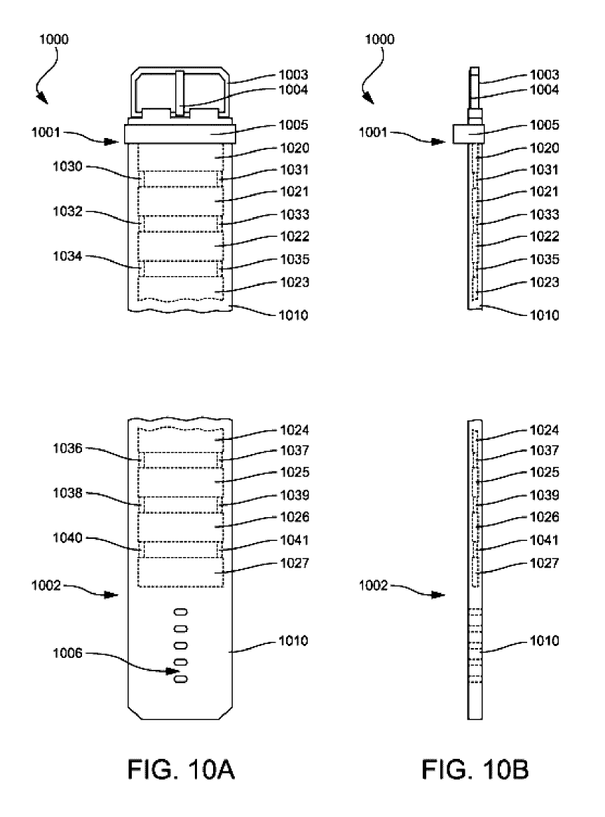

FIGS. 10A and 10B schematically illustrate a further preferred embodiment of a two part flexible electronic strap 1000. The electronic strap comprises a first strap portion 1001 with a tang clasp, which has a buckle 1003 and a center fastening pin, tongue, or pronge 1004, and a strap fastening loop member 1005, and is attached to an end of the strap portion 1001, and a second strap portion 1002 with a row of holes 1006 inserted in an end of the strap portion 1002. For fastening a wearable computer, which is arranged between the other ends of the strap portions 1001, 1002, on a body part of a user the end of the strap portion 1002 is inserted through the buckle 1003 at first, then the pin 1004 is inserted in one of the holes 1006, and finally the end of the strap portion 1002 is inserted through the fastening loop member 1005.

The strap portions 1001, 1002 are made of a flexible material 1010 for contact with a body part of a user.

The strap portion 1001 is embedding a series of electrical energy storage devices 1020 to 1023, and the strap portion 1002 is embedding a series of electrical energy storage devices 1024 to 1027. By way of non-limiting example, the electrical energy storage devices are of the type solid or flexible thin film batteries. The electrical energy storage devices 1020 to 1023 are electrically connected by conductive members 1030 to 1035, and the electrical energy storage devices 1024 to 1027 are electrically connected by conductive members 1036 to 1041 in a flexible way.

With such a configuration of electrical energy storage device series 1020 to 1023, and 1024 to 1027 embedded within the strap portions 1001, 1002 the electronic strap of a wearable computer can be constructed in different ways for more aesthetical appearance for example. In addition, by connecting small battery cells in parallel the temperature created by a high-power demand is distributed on the one hand and the battery life per charge can be extended on the other hand.

FIG. 10B shows the same configuration illustrated in FIG. 10A as a sectional side view. Therefore, the corresponding portions are denoted by the same reference numerals and the explanation is omitted.

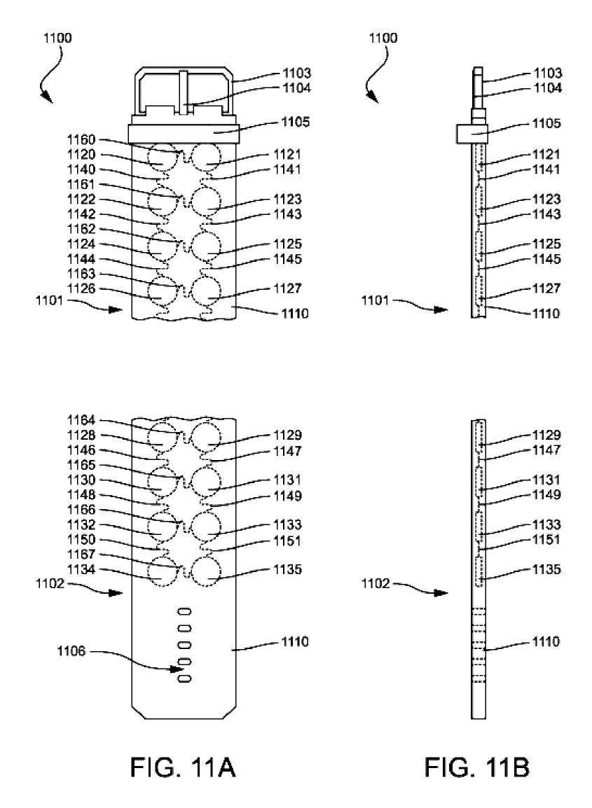

FIGS. 11A and 11B schematically illustrate a preferred embodiment of a two part flexible and stretchable electronic strap 1100. The electronic strap comprises a first strap portion 1101 with a tang clasp, which has a buckle 1103 and a center fastening pin, tongue, or pronge 1104, and a strap fastening loop member 1105, and is attached to an end of the strap portion 1101, and a second strap portion 1102 with a row of holes 1106 inserted in an end of the strap portion 1102. For fastening a wearable computer, which is arranged between the other ends of the strap portions 1101, 1102, on a body part of a user the end of the electronic strap 1102 is inserted through the buckle 1103 at first, then the pin 1104 is inserted in one of the holes 1106, and finally the end of the strap portion 1102 is inserted through the fastening loop member 1105.

The strap portions 1101, 1102 are made of a flexible and stretchable material 1110 for contact with a body part of a user.

The strap portion 1101 is embedding a series of electrical energy storage devices 1120 to 1127, and the strap portion 1102 is embedding the series of electrical energy storage devices 1128 to 1135. By way of non-limiting example, the electrical energy storage devices are of the type solid or flexible thin film button cells or coin cells. The button cells or coin cells 1120 to 1127 are electrically connected by conductive zigzag members 1140 to 1145 and 1160 to 1163, and the button cells or coin cells 1128 to 1135 are electrically connected by conductive zigzag members 1146 to 1151 and 1164 to 1167 in a flexible and stretchable way.

With such a configuration of electrical energy storage device series 1120 to 1127, and 1128 to 1135 embedded within the strap portions 1101, 1102 the complete flexible electronic strap can also be constructed in a stretchable way within the limits of the used electrical elements, and in more aesthetical ways for example. In addition, by connecting small battery cells in parallel the temperature created by a high-power demand is distributed on the one hand and the battery life per charge can be extended on the other hand.

FIG. 11B shows the same configuration illustrated in FIG. 11A as a sectional side view. Therefore, the corresponding portions are denoted by the same reference numerals and the explanation is omitted.

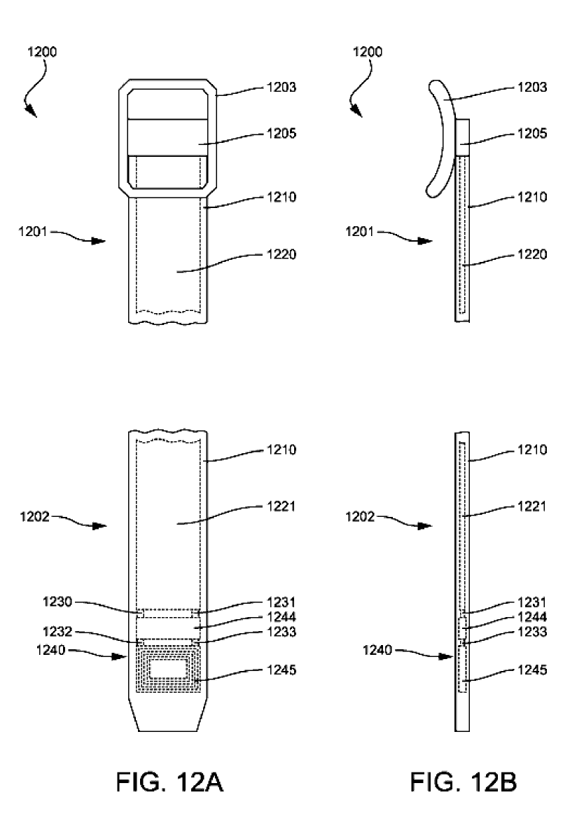

FIGS. 12A and 12B schematically illustrate a preferred embodiment of a two part flexible electronic strap 1200. The electronic strap comprises a first strap portion 1201 with a buckle 1203, which has a mounting means 1205 integrally formed on the buckle 1203, and is fixedly attached to an end of the strap portion 1201 by the mounting means 1205, and a second strap portion 1202. For fastening a wearable computer, which is arranged between the other ends of the strap portions 1201, 1202, on a body part of a user the end of the strap segment 1202 is inserted through the buckle 1203, which has also the function of a fastening loop.

The strap portions 1201, 1202 are made of a flexible material 1210 for contact with a body part of a user.

The strap portion 1201 is embedding a substantially flat and flexible electrical energy storage device 1220, and the strap portion 1202 is embedding a substantially flat and flexible electrical energy storage device 1221, and a wireless charging module 1240, which is configured to wirelessly collect external energy for charging the electrical energy storage device 1221. In alternative embodiments, the wireless charging module 1240 can be configured to charge all electrical energy storage devices of a wearable computer by using an additional selective switching circuitry and additional conductive members for the related electrical connections of the other electrical energy storage devices, or/and arranged within a central portion of a wearable computer

In the illustrated embodiment, shown in FIGS. 12A and 12B, the wireless charging module 1240 includes a receiving charging coil 1245 for collecting wireless electromagnetic energy emitted by a transmitting coil of an external power source not shown in the illustration for better clarity, and a control and conversion circuitry 1244 for controlling the charging operation and converting the collected wireless electromagnetic energy into electric power having a predetermined voltage to charge the electrical energy storage device 1221. The electrical energy storage device 1221 is electrically connected to the control and conversion circuitry 1244 by conductive members 1230, 1231, and the control and conversion circuitry 1244 is electrically connected to the charging coil 1245 by conductive members 1232, 1233.

With such a configuration of the rechargeable electrical energy storage device 1221 and the wireless charging module 1240 embedded within the strap segment 1202, or with alternative configurations as discussed above, the charging process of an electronic strap can be effectively simplified without affecting the size of a wearable computer.

FIG. 12B shows the same configuration illustrated in FIG. 12A as a sectional side view. Therefore, the corresponding portions are denoted by the same reference numerals and the explanation is omitted.

A similar electronic strap is disclosed in U.S. Pat. No. 8,908,479, issued Dec. 9, 2014, and entitled “Electronic wrist watch having wireless charging function”, which is hereby incorporated herein by reference.

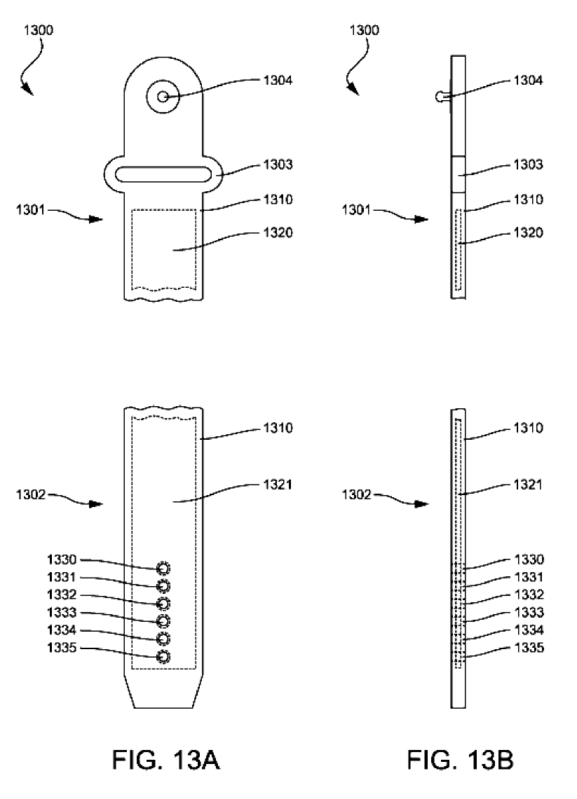

FIGS. 13A and 13B schematically illustrate a preferred embodiment of a two part flexible electronic strap 1300. The electronic strap comprises a first strap portion 1301 with a buckle clasp, which has a buckle 1303 and a stud 1304, and is attached to an end of the strap portion 1301, and a second strap portion 1302 with a row of holes 1330 to 1335 inserted in an end of the strap portion 1302. For fastening a wearable computer, which is arranged between the other ends of the strap portions 1301, 1302, on a body part of a user one of the holes 1330 to 1335 of the end of the strap portion 1302 is put over the stud 1304 of the end of the strap portion 1301 at first, and finally the end of the strap portion 1302 is inserted through the buckle 1303.

In an alternative embodiment, the positions of the buckle 1303 and the stud 1304 on the end of the strap portion 1301 can be exchanged with each other, which would also require to change the steps of fastening the strap.

The strap portions 1301, 1302 are made of a flexible material 1310 for contact with a body part of a user.

The strap portion 1301 is embedding a substantially flat and flexible electrical energy storage device 1320, and the strap portion 1302 is embedding a substantially flat and flexible electrical energy storage device 1321. In the illustrated embodiment, the single holes 1330 to 1335 inserted in the end of the strap portion 1302 are also inserted in the electrical energy storage device 1321 without exposing any portion of the electrical energy storage device 1321 to the outside for increasing the capacity of the electrical energy storage device 1321.

FIG. 13B shows the same configuration illustrated in FIG. 13A as a sectional side view. Therefore, the corresponding portions are denoted by the same reference numerals and the explanation is omitted.

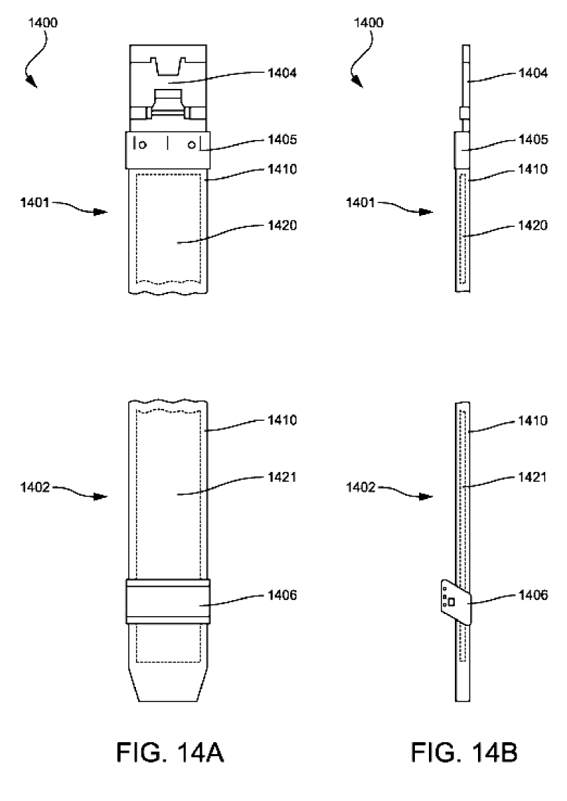

FIGS. 14A and 14B schematically illustrate a preferred embodiment of a two part flexible electronic strap 1400. The electronic strap comprises a first strap portion 1401 with a first clasp portion 1404, which has a mounting means 1405, and is fixedly attached to an end of the strap portion 1401 by the mounting means 1405, and a second strap portion 1402 with a second clasp portion 1406, which is slidably mounted on an end of the strap portion 1402. For fastening a wearable computer, which is arranged between the other ends of the strap portions 1401, 1402, on a body part of a user the clasp portion 1404 is plugged into the clasp portion 1406.

The strap portions 1401, 1402 are made of a flexible material 1410 for contact with a body part of a user.

The strap portion 1401 is embedding a substantially flat and flexible electrical energy storage device 1420, and the strap portion 1402 is embedding a substantially flat and flexible electrical energy storage device 1421.

FIG. 14B shows the same configuration illustrated in FIG. 14A as a sectional side view. Therefore, the corresponding portions are denoted by the same reference numerals and the explanation is omitted.

A similar electronic strap is disclosed in U.S. Pat. No. 5,742,256, issued Apr. 21, 1998, and entitled “Wristband having embedded electrically conductive members for a wrist-mountable type electronic device”, which is already incorporated herein by reference.

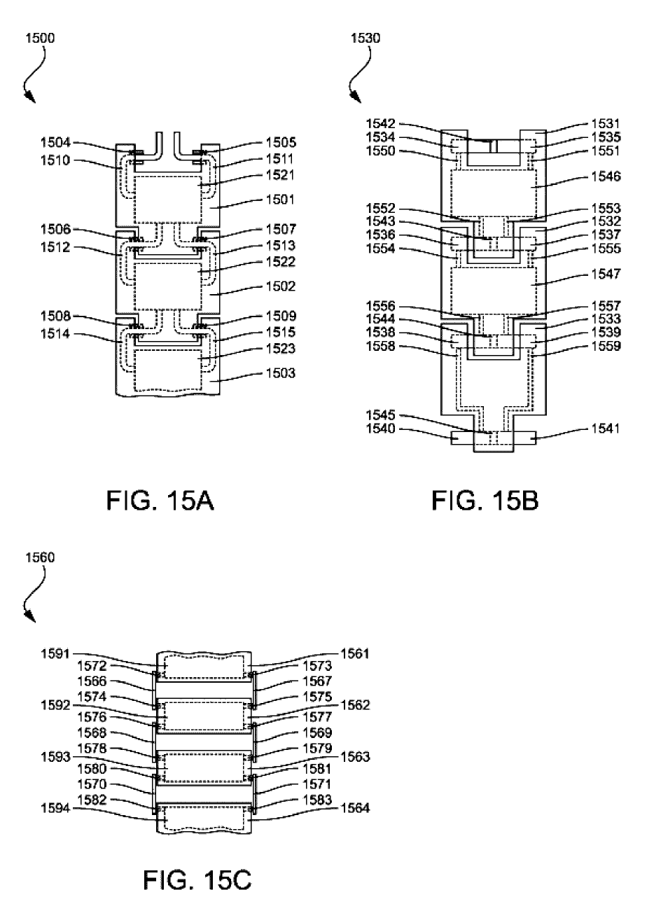

FIGS. 15A, 15B, and 15C schematically illustrate preferred embodiments of link arrangements 1500, 1530, and 1560 of an electronic bracelet.

FIG. 15A illustrates one such embodiment in which a link arrangement 1500 of an electronic bracelet comprises a plurality of links 1501, 1502, and 1503 rotatably connected to their adjacent links by pairs of hollow barrels 1504, 1505, 1506, 1507, and 1508, 1509. Each of the links 1501, 1502, and 1503 is embedding pairs of conductive, insulated wires 1510, 1511, 1512, 1513, and 1514, 1515, and electrical energy storage devices 1521, 1522, and 1523 electrically connected by the insulated wire pairs accordingly. The wire pairs 1510, 1511, 1512, 1513, and 1514, 1515 are inserted through the pairs of hollow barrels 1504, 1505, 1506, 1507, and 1508, 1509 accordingly. By way of non-limiting example, the electrical energy storage devices are of the type solid or flexible thin film batteries. In the case that the links 1501, 1502, and 1503 are made of a metallic material each of the electrical energy storage devices 1521, 1522, and 1523 may be contained in an insulating case or wrapped in an insulating sheet.

In addition and without any intention to limit the scope of the disclosure, the electronic bracelet segment 1500 can have the link 1501 as an end piece configured as the base sections 409, 429 illustrated in FIGS. 4B and 4C.

Similar electronic bracelets are disclosed in U.S. Pat. No. 5,615,179, issued Mar. 25, 1997, and entitled “Electronic apparatus with fitting band”, which is already incorporated herein by reference.

FIG. 15B illustrates another embodiment in which a link arrangement 1530 of an electronic bracelet comprises a plurality of links 1531, 1532, and 1533 rotatably connected and electrically coupled to their adjacent links by cylindrical, conductive pairs of connectors 1534, 1535 to 1540, 1541, which may be two separate members or a single member with an insulator 1542 to 1545 located between the pairs of connectors.

The links 1531, 1532, and 1533 are embedding pairs of electrically conductive members 1550, 1551 to 1558, 1559. The links 1531, 1532 are also embedding electrical energy storage devices 1546, 1547, which are electrically connected to the connector pairs 1534, 1535 to 1540, 1541 by the conductive member pairs 1550, 1551 to 1558, 1559 accordingly. By way of non-limiting example, the electrical energy storage devices are of the type solid or flexible thin film batteries. In the case that the links 1531, 1532 are made of a metallic material each of the electrical energy storage devices 1546, 1547 may be contained in an insulating case or wrapped in an insulating sheet.

In addition, each of the links 1531, 1532, and 1533 may simply serve as a linkage in an electronic bracelet, or may include an electrical energy storage device. In the example shown in FIG. 15B the link 1531 includes the electrical energy storage device 1546, the link 1532 includes the electrical energy storage device 1547, and the link 1553 simply serves as a linkage on the link arrangement 1530 of an electronic bracelet. Embedding an electrical energy storage device as a link in an electronic bracelet provides for adding, replacing, or removing auxiliary electrical energy storage devices to or from a wearable computer. For example, the link 1553 may be replaced with a link including an auxiliary electrical energy storage device.

A similar electronic bracelet is disclosed in U.S. Pat. No. 8,467,270, issued Jun. 18, 2013, and entitled “Smart-watch with user interface features”, which is hereby incorporated herein by reference.

FIG. 15C illustrates a further embodiment in which a link arrangement 1560 of an electronic bracelet comprises a plurality of links 1561 to 1564 rotatably connected to their adjacent links by pairs of conductive connectors 1566, 1567 to 1570, 1571. The links 1561 to 1564 are embedding pairs of electrically conductive members 1572, 1573 to 1582, 1583, and electrical energy storage devices 1591 to 1594, which are electrically connected to the conductive connector pairs 1566, 1567 to 1570, 1571 by the conductive member pairs 1572, 1573 to 1582, 1583 accordingly. By way of non-limiting example, the electrical energy storage devices are of the type solid or flexible thin film batteries. In the case that the links 1561 to 1564 are made of a metallic material each of the electrical energy storage devices 1591 to 1594 may be contained in an insulating case or wrapped in an insulating sheet.

It is understood that the linkage arrangements shown in FIGS. 15A, 15B, and 15C are non-limiting examples, and that the present disclosure applies to a variety of alternate linkage arrangements including, but not limited to, the examples shown in FIGS. 15A, 15B, and 15C. In this respect, it is also understood that one skilled in the art is able to realize end pieces respectively base sections that are integrated with the attachment structures illustrated in FIGS. 1A, 1B, and 1C to 6A, 6B, and 6C, and 7A, 7B, 7C, and 7D, and to embedded the link arrangements in a material, or sandwich between inner and outer material layers as illustrated in the FIGS. 8A, 8B, and 8C.

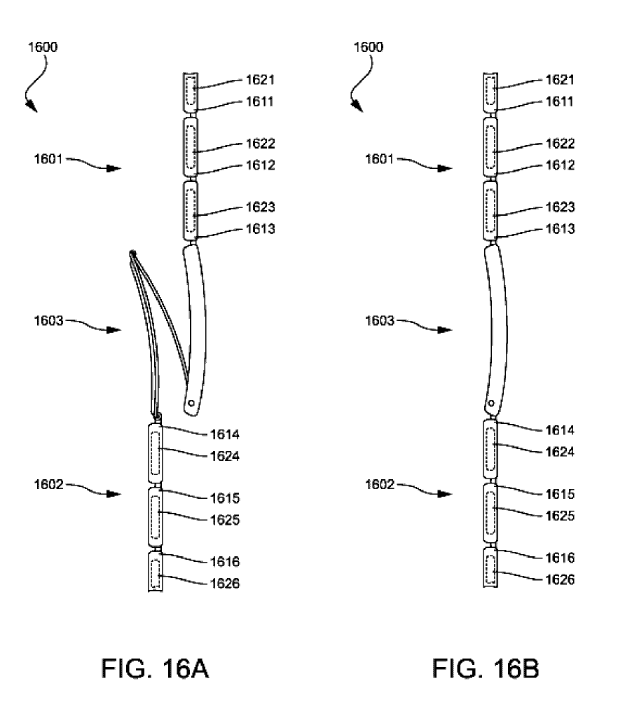

FIGS. 16A and 16B schematically illustrate a preferred embodiment of an electronic bracelet 1600. The electronic bracelet comprises a first bracelet portion 1601, a second bracelet portion 1602, and a deployment clasp or fold-over clasp 1603 connecting the bracelet portions 1601, 1602 with each other. FIG. 16A shows the opened deployment clasp 1603. For fastening a wearable computer on a body part of a user the deployment clasp 1603 has to be closed as shown in FIG. 16B.

The bracelet portion 1601 comprises links 1611, 1612, and 1613, each embedding electrical energy storage devices 1621, 1622, and 1623, and the bracelet portion 1602 comprises links 1614, 1615, and 1616, each embedding electrical energy storage devices 1624, 1625, and 1626. The links 1611 to 1616 may be made of a metallic material or a non-metallic material. In the case that the links 1611 to 1616 are made of a metallic material each of the electrical energy storage devices 1621 to 1626 may be contained in an insulating case or wrapped in an insulating sheet.

Without any intention to limit the scope of the disclosure, in modifications of the embodiment shown in FIGS. 16a and 16B the links may be formed as illustrated in FIGS. 15A, 15B, and 15C, and the electrical energy storage devices are of the type solid or flexible thin film batteries.

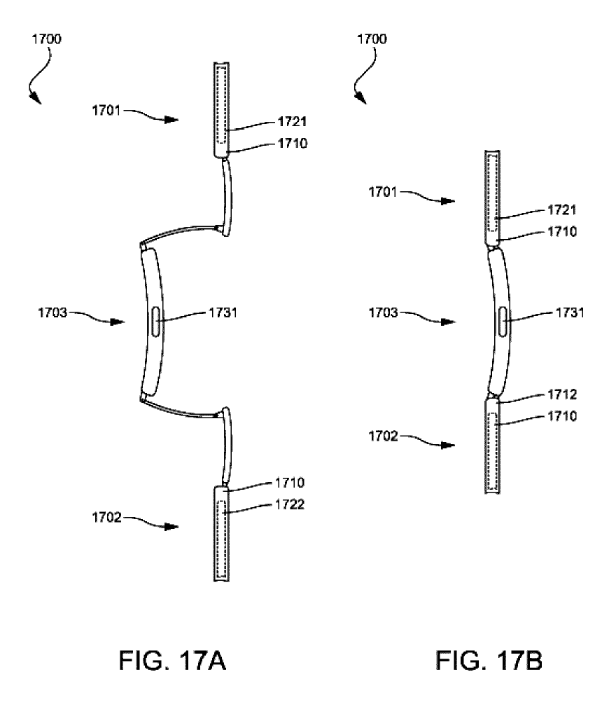

FIGS. 17A and 17B schematically illustrate a preferred embodiment of a flexible electronic strap 1700. The electronic strap comprises a first strap portion 1701, a second strap portion 1702, and a hidden deployment clasp, dual clasp, or butterfly clasp 1703 with a single push button 1705 connecting the strap portions 1701, 1702 with each other. FIG. 17A shows the opened hidden deployment clasp 1703. For fastening a wearable computer on a body part of a user the hidden deployment clasp 1703 has to be closed as shown in FIG. 17B.

By pushing the push button 1705 the hidden deployment clasp 1703 can be opened and the wearable computer can be removed from the body part of the user again.

The strap portions 1701, 1702 are made of a flexible material 1710 for contact with a body part of a user.

The strap portion 1701 is embedding an electrical energy storage device 1721, and the strap portion 1702 is embedding an electrical energy storage device 1722. By way of non-limiting example, the electrical energy storage devices are of the type solid or flexible thin film batteries.

The specification and drawings are, accordingly, to be regarded in an illustrative rather than a restrictive sense. It will, however, be evident that various modifications and changes may be made thereunto by those skilled in the art without departing from the broader spirit and scope of the invention as set forth in the claims. In other words, although embodiments have been described with reference to a number of illustrative embodiments thereof, this disclosure is not limited to those. Accordingly, in various embodiments of the invention the various embodiments of the attachment structure and central portion of a wearable computer discussed and suggested in FIGS. 1A, 1B, and 1C to 6A, 6B, and 6C, and 7A, 7B, 7C, and 7D can be combined with the various embodiments of the electronic strap respectively electronic bracelet discussed and suggested in FIGS. 8A, 8B, and 8C, 9A, 9B, and 9C, 10A and 10B to 14A and 14B, 15A, 15B, and 15C, 16A and 16B, and 17A and 17B on the one hand, and on the other hand the various embodiments of the clasp means, materials, electrical energy storage devices, conductive members, links, and connectors of an electronic strap respectively electronic bracelet discussed and suggested in FIGS. 8A, 8B, and 8C, 9A, 9B, and 9C, 10A and 10B to 14A and 14B, 15A, 15B, and 15C, 16A and 16B, and 17A and 17B can be combined with each other in appropriate ways. The scope of the present disclosure shall be determined only by the appended claims and their equivalents. In addition, variations and modifications in the component parts, arrangements, or/and alternative uses must be regarded as included in the appended claims.

1. A wearable computer comprising:
an electronic module including:
at least one processor for processing arbitrary informations,
at least one data memory for storing arbitrary data,
at least one control circuitry being configured for performing predetermined functions of the wearable computer, and
at least one pair of conductive, positive and negative contacts being configured as electrical power connection;
a central portion for housing the electronic module therein;
at least one rechargeable electrical energy storage device for providing electric power to the electronic module, said at least one energy storage device including:
at least one battery cell, and
at least one pair of conductive, positive and negative contacts;
a strap for mounting the wearable computer on a body part of a user, and for containing at least one electrical energy storage device therein;
a fastening means for mechanically fastening the strap to the central portion, said fastening means comprising:
a first fastening means for fastening a first end of said strap to a first side of said central portion, and
a second fastening means for fastening a second end of said strap to a second side of said central portion;
and
a coupling means for electrically coupling the strap to the central portion, said coupling means comprising:
at least one pair of cylindrical, conductive, positive and negative pins having ends, and
at least one pair of complementary conductive, positive and negative insert elements,
wherein the conductive pins of said at least one pair of conductive pins are arranged within said strap, insulated from each other, and electrically coupled to at least one pair of conductive, positive and negative contacts of at least one energy storage device,
wherein the conductive insert elements of said at least one pair of conductive insert elements are arranged within said central portion, insulated from each other and from said central portion, and electrically coupled to at least one pair of conductive, positive and negative contacts of the electronic module, and
wherein said conductive pin ends are engaging said conductive insert elements, so that said at least one electrical energy storage device being contained in said strap is conductively coupled to said electronic module being contained in said central portion.

2. The wearable computer according to claim 1,
wherein at least one battery cell of at least one electrical energy storage device includes one of (a) a metal-ion battery cell, (b) a metal-ion polymer battery cell, (c) a metal-ion air battery cell, (d) a metal-ion ceramic battery cell, (e) a printed circuit metal-ion battery cell, or (f) a metal-ion foil battery cell.

3. The wearable computer according to claim 1,
wherein at least one battery cell of at least one electrical energy storage device is a flexible battery cell.

4. The wearable computer according to claim 1,
wherein the strap is a single, continuous strap.

5. The wearable computer according to claim 1,
wherein the strap further comprises:
a first strap portion containing a first rechargeable electrical energy storage device therein;
a second strap portion containing a second rechargeable electrical energy storage device therein; and
a clasp means for mechanically fastening a first end of said first strap portion and a first end of said second strap portion together, and for removably securing the wearable computer on a body part of a user;
wherein the fastening means further comprises:
a first fastening means for fastening the second end of said first strap portion to a first side of the central portion; and
a second fastening means for fastening the second end of said second strap portion to a second side of the central portion;
and
wherein the coupling means further comprises:
a first pair of cylindrical, conductive, positive and negative pins with ends;
a first pair of complementary conductive, positive and negative insert elements;
a second pair of cylindrical, conductive, positive and negative pins with ends; and
a second pair of complementary conductive, positive and negative insert elements,
wherein the conductive pins of said first pair of conductive pins are arranged within said second end of said first strap portion, insulated from each other, and electrically coupled to at least one pair of conductive, positive and negative contacts of said first energy storage device,
wherein the conductive insert elements of said first pair of insert elements are arranged within said central portion, insulated from each other and from said central portion, and electrically coupled to at least one pair of conductive, positive and negative contacts of the electronic module,
wherein the conductive pins of said second pair of conductive pins are arranged within said second end of said second strap portion, insulated from each other, and electrically coupled to at least one pair of conductive, positive and negative contacts of said second energy storage device,
wherein the conductive insert elements of said second pair of insert elements are arranged within said central portion, insulated from each other and from said central portion, and electrically coupled to at least one pair of conductive, positive and negative contacts of the electronic module, and
wherein the ends of said first pair of pins are engaging said first pair of insert elements, and the ends of said second pairs of pins are engaging said second pair of insert elements, so that said first energy storage device being contained in said first strap portion and said second energy storage device being contained in said second strap portion are conductively coupled to said electronic module being contained in said central portion.

6. The wearable computer according to claim 1,
wherein at least one segment of the strap further comprises:
an electrically insulating inner layer member being made of a first material for contact with a body part of a user; and
an electrically insulating outer layer member being made of a second material,
wherein at least one of said inner and outer layer members includes extended portions on two opposite sides along the lengthwise direction, said extended portions are extending beyond adjacent edges of at least one energy storage device being contained in said strap segment, and covering at least a portion of adjacent edges of the other layer member, and
wherein at least one energy storage device is sandwiched between said inner layer member and said outer layer member.

7. The wearable computer according to claim 6,
wherein the first and second materials include one of (a) a non-metallic material, such as (b) a natural leather, (c) an artificial leather, (d) a natural elastomer or natural rubber, (e) an artificial elastomer, (f) a synthetic rubber, and (g) a polyurethane, or one of (h) a metallic material.

8. The wearable computer according to claim 1,
wherein at least one portion of the strap is a bracelet, said bracelet comprising:
a plurality of links,
wherein adjacent links of said plurality of links are mechanically coupled together,
wherein at least one link of said plurality of links contains a battery cell of at least one energy storage device,
wherein adjacent battery cells, disposed in respective adjacent links of said plurality of links, are electrically coupled together,
wherein at least one battery cell provides power to the electronic module, and
wherein at least one of said plurality of links is removable from and attachable to said bracelet by a user of the wearable computer to permit the user to adjust a size of said bracelet to a body part of the user.

9. The wearable computer according to claim 1,
wherein at least one pin of at least one pair of cylindrical, conductive, positive and negative pins of the coupling means further comprises:
a hollow, conductive barrel section being insulated from its opposite pin, and electrically coupled to at least one pair of conductive, positive and negative contacts of at least one energy storage device; and
a conductive spring-loaded extension section being inserted into said hollow, conductive barrel section, and configured as the end of said pin,
wherein said conductive spring-loaded extension is engaging a corresponding conductive insert element being arranged within the central portion.

10. The wearable computer according to claim 1,
wherein at least one pin of at least one pair of cylindrical, conductive, positive and negative pins of the coupling means further comprises:
a hollow, conductive barrel section being insulated from its opposite pin, and electrically coupled to at least one pair of conductive, positive and negative contacts of at least one energy storage device; and
a conductive extension section being pluggable into said hollow, conductive barrel section, and configured as the end of said pin;
wherein the central portion further comprises:
at least one screw hole being included therein, and extending in line with said pin;
wherein at least one insert element of at least one pair of complementary conductive, positive and negative insert elements of the coupling means further comprises:
a pin through-hole being included therein, and extending in line with said at least one screw hole;
and
wherein the fastening means further comprises:
at least one screw being configured to fit into said at least one screw hole, and insulated from the coupling means;
wherein said conductive extension section is inserted through said pin through-hole and into said hollow, conductive barrel section, and
wherein said at least one screw is fastened in said screw hole to lock said conductive extension from moving off the strap and the central portion.

11. The wearable computer according to claim 1,
wherein the fastening means and the coupling means form a hinge, said hinge being configured to pivotably fasten and couple the strap to the central portion.

12. The wearable computer according to claim 1,
wherein the coupling means further comprises:
a sealing means for waterproofing said coupling means, said sealing means comprising:
at least one ring-shaped seal for each end of the coupling conductive pins,
wherein said ring-shaped seals are arranged around said conductive pin ends, and between the strap and the corresponding conductive insert elements of the central portion.

13. The wearable computer according to claim 5,
wherein the clasp means includes one of (a) a buckle, (b) a buckle clasp with stud, (c) a tang clasp, pin buckle, or buckle with tongue or prong, (c) a ratchet buckle, (d) a deployment clasp or fold-over clasp, such as (e) a deployment clasp with buckle, (f) a deployment clasp with safety, (g) a deployment clasp with at least one push button, and (h) a hidden deployment clasp, dual clasp, or butterfly clasp, (i) a hook and loop fastener, or (j) a releasably secure fastener, such as (k) a quick release fastener, (I) a side release fastener, and (m) a snap-fit fastener

14. The wearable computer according to claim 1, further comprising:
at least one display device for displaying informative data, said display device being integrated with the central portion, and connected to the electronic module.

15. The wearable computer according to claim 14,
wherein at least one display device includes one of (a) an active display, such as (b) a liquid crystal display, (c) a vacuum field emission display, (d) an electroluminescent display, (e) a plasma liquid crystal display, (f) a light emitting diode display, and (g) a laser display, or one of (h) a passive or reflective display, such as (i) an e-paper and (j) an interferometric modulator display.

16. The wearable computer according to claim 1, further comprising:
at least one rechargeable energy storage device being contained in the central portion; and
a selective switching circuitry for selectively taking out electric power from at least one energy storage device being contained in the strap and from said at least one energy storage device being contained in the central portion, and for selectively supplying electric power therein.

17. The wearable computer according to claim 1, further comprising:
a case for housing the electronic module, said case including:
at least one pair of conductive, positive and negative contacts being configured as a first electrical connector, and
at least one rechargeable electrical energy storage device,
wherein said at least one pair of conductive, positive and negative contacts are electrically connected to at least one pair of conductive, positive and negative contacts of said electronic module, and
wherein said at least one electrical energy storage device is electrically connected to at least one pair of conductive, positive and negative contacts of said electronic module, so that said case with said electronic module
is independently useable as a portable electronic device apart from the strap;
and
a receptacle area being molded in the central portion, and configured to receive and electrically connect to the case, said receptacle area including:
at least one pair of conductive, positive and negative contacts being configured as a second electrical connector,
wherein said at least one pair of conductive, positive and negative contacts are electrically coupled to at least one pair of conductive, negative and positive insert elements being arranged within said central portion, and
wherein said second electrical connector is used at least in part to removably secure said case, and electrically coupled to the first electrical connector of said case when provided therein, so that the electronic module is electrically connected to at least one energy storage device contained in the strap via said first and second electrical connectors, and supplied with electric power.

18. The wearable computer according to claim 1, further comprising:
a case for housing the electronic module, said case including:
at least one pair of conductive, positive and negative contacts being configured as a first electrical connector, and
at least one rechargeable electrical energy storage device,
wherein said at least one pair of conductive, positive and negative contacts are electrically connected to at least one pair of conductive, positive and negative contacts of said electronic module, and
wherein said at least one electrical energy storage device is electrically connected to at least one pair of conductive, positive and negative contacts of said electronic module, so that said case with said electronic module is independently useable as a portable electronic device apart from the strap;
and
an opening being molded in the central portion, and configured to receive and electrically connect to the case, said opening including:
at least one pair of conductive, positive and negative contacts being configured as a second electrical connector,
wherein said at least one pair of conductive, positive and negative contacts are electrically coupled to at least one pair of conductive, negative and positive insert elements being arranged within said central portion, and
wherein said second electrical connector is used at least in part to removably secure said case, and electrically coupled to the first electrical connector of said case when provided therein, so that the electronic module is electrically connected to at least one energy storage device contained in the strap via said first and second electrical connectors, and supplied with electric power.

19. The wearable computer according to claim 1, further comprising:
a wireless charging module being electrically coupled to at least one energy storage device, and configured to wirelessly collect external energy for charging said energy storage device.

20. The wearable computer according to claim 19,
wherein the wireless charging module comprises:
a receiving coil being configured to collect wireless electromagnetic energy emitted by a transmitting coil of an external power source; and
a conversion module being configured to convert said collected wireless electromagnetic energy into electric power having a predetermined voltage for charging at least one energy storage device.

21. A wearable computer comprising:
an electronic module including:
at least one processor configured to process arbitrary informations,
at least one data memory being configured to store arbitrary data,
at least one control circuitry being configured to perform predetermined functions of the wearable computer, and
at least one pair of conductive, positive and negative contacts being configured as electrical power connection;
a central portion for housing the electronic module therein;
at least one rechargeable electrical energy storage device for providing electric power to the electronic module, said at least one energy storage device including:
at least one battery cell, and
at least one pair of conductive, positive and negative contacts;
a strap for mounting the wearable computer on a body part of a user, and for containing at least one electrical energy storage device therein;
a fastening means for mechanically fastening the strap to the central portion, said fastening means comprising:
a first fastening means for fastening a first end of said strap to a first side of said central portion, and
a second fastening means for fastening a second end of said strap to a second side of said central portion;
and
a coupling means for electrically coupling the strap to the central portion, said coupling means comprises:
at least one pair of hollow barrels being configured as communication holes,
at least one conductive, positive cable, and
at least one conductive, negative wire,
wherein said at least one conductive, positive cable is routed through one hollow barrel of said at least one pair of hollow barrels, electrically coupled at one end to at least one conductive, positive contact of at least one electrical energy storage device, and electrically coupled at its opposite end to at least one conductive, positive contact of the electronic module, and said at least one conductive, negative cable is routed through one hollow barrel of said at least one pair of hollow barrels, electrically coupled at one end to at least one conductive, negative contact of at least one electrical energy storage device, and electrically coupled at its opposite end to at least one conductive, negative contact of the electronic module, so that at least one electrical energy storage device being contained in said strap is conductively coupled to said electronic module being contained in said central portion.

22. The wearable computer according to claim 21,
wherein at least one battery cell of at least one electrical energy storage device includes one of (a) a metal-ion battery cell, (b) a metal-ion polymer battery cell, (c) a metal-ion air battery cell, (d) a metal-ion ceramic battery cell, (e) a printed circuit metal-ion battery cell, or (f) a metal-ion foil battery cell.

23. The wearable computer according to claim 21,
wherein at least one battery cell of at least one electrical energy storage device is a flexible battery cell.

24. The wearable computer according to claim 21,
wherein the strap is a single, continuous strap.

25. The wearable computer according to claim 21,
wherein the strap further comprises:
a first strap portion containing a first rechargeable electrical energy storage device therein;
a second strap portion containing a second rechargeable electrical energy storage device therein; and
a clasp means for mechanically fastening a first end of said first strap portion and a first end of said second strap portion together, and for removably securing the wearable computer on a body part of a user;
wherein the fastening means further comprises:
a first fastening means for fastening the second end of said first strap portion to a first side of the central portion; and
a second fastening means for fastening the second end of said second strap portion to a second side of the central portion;
and
wherein the coupling means further comprises:
a first pair of hollow barrels;
a first conductive, positive wire;
a first conductive, negative wire;
a second pair of hollow barrels;
a second conductive, positive wire; and
a second conductive, negative wire,
wherein said first and second pairs of hollow barrels are configured as communication holes,
wherein said first conductive, positive wire is routed through one hollow barrel of said first pair of hollow barrels, electrically coupled at one end to at least one conductive, positive contact of said first electrical energy storage device of said first strap portion, and electrically coupled at the opposite end to at least one conductive, positive contact of the electronic module, and said first conductive, negative wire is routed through one hollow barrel of said first pair of hollow barrels, electrically coupled at one end to at least one conductive, negative contact of said first electrical energy storage device of said first strap portion, and electrically coupled at the opposite end to at least one conductive, negative contact of the electronic module, so that said first energy storage device being contained in said first strap portion is conductively coupled to said electronic module being contained in said central portion, and
wherein said second conductive, positive wire is routed through one hollow barrel of said second pair of hollow barrels, electrically coupled at one end to at least one conductive, positive contact of said second electrical energy storage device of said second strap portion, and electrically coupled at the opposite end to at least one conductive, positive contact of the electronic module, and said second conductive, negative wire is routed through one hollow barrel of said second pair of hollow barrels, electrically coupled at one end to at least one conductive, negative contact of said second electrical energy storage device of said second strap portion, and electrically coupled at the opposite end to at least one conductive, negative contact of the electronic module,
so that said second energy storage device being contained in said second strap portion is conductively coupled to said electronic module being contained in said central portion.

26. The wearable computer according to claim 21,
wherein at least one segment of the strap further comprises:
an electrically insulating inner layer member being made of a first material for contact with a body part of a user; and
an electrically insulating outer layer member being made of a second material,
wherein at least one of said inner and outer layer members includes extended portions on two opposite sides along the lengthwise direction, said extended portions are extending beyond adjacent edges of at least one energy storage device being contained in said strap segment, and covering at least a portion of adjacent edges of the other layer member, and
wherein at least one energy storage device is sandwiched between said inner layer member and said outer layer member.

27. The wearable computer according to claim 26,
wherein the first and second materials include one of (a) a non-metallic material, such as (b) a natural leather, (c) an artificial leather, (d) a natural elastomer or natural rubber, (e) an artificial elastomer, (f) a synthetic rubber, and (g) a polyurethane, or one of (h) a metallic material.

28. The wearable computer according to claim 21,
wherein at least one portion of the strap is a bracelet, said bracelet comprising:
a plurality of links,
wherein adjacent links of said plurality of links are mechanically coupled together,
wherein at least one link of said plurality of links contains a battery cell of at least one energy storage device,
wherein adjacent battery cells, disposed in respective adjacent links of said plurality of links, are electrically coupled together,
wherein at least one battery cell provides power to the electronic module, and
wherein at least one of said plurality of links is removable from and attachable to said bracelet by a user of the wearable computer to permit the user to adjust a size of said bracelet to a body part of the user.

29. The wearable computer according to claim 21,
wherein the fastening means and the coupling means form a hinge, said hinge being configured to pivotably fasten and couple the strap to the central portion.

30. The wearable computer according to claim 21,
wherein the coupling means further comprises:
a sealing means for waterproofing said coupling means, said sealing means comprising:
at least one ring-shaped seal for each coupling barrel,
wherein said ring-shaped seals are arranged around said barrels, and between the strap and the central portion.

31. The wearable computer according to claim 25,
wherein the clasp means includes one of (a) a buckle, (b) a buckle clasp with stud, (c) a tang clasp, pin buckle, or buckle with tongue or prong, (c) a ratchet buckle, (d) a deployment clasp or fold-over clasp, such as (e) a deployment clasp with buckle, (f) a deployment clasp with safety, (g) a deployment clasp with at least one push button, and (h) a hidden deployment clasp, dual clasp, or butterfly clasp, (i) a hook and loop fastener, or (j) a releasably secure fastener, such as (k) a quick release fastener, (I) a side release fastener, and (m) a snap-fit fastener.

32. The wearable computer according to claim 21, further comprising:
at least one display device for displaying informative data, said display device being integrated with the central portion, and connected to the electronic module.

33. The wearable computer according to claim 32,
wherein at least one display device includes one of (a) an active display, such as (b) a liquid crystal display, (c) a vacuum field emission display, (d) an electroluminescent display, (e) a plasma liquid crystal display, (f) a light emitting diode display, and (g) a laser display, or one of (h) a passive or reflective display, such as (i) an e-paper and (j) an interferometric modulator display.

34. The wearable computer according to claim 21, further comprising:
at least one rechargeable energy storage device being contained in the central portion; and
a selective switching circuitry for selectively taking out electric power from at least one energy storage device being contained in the strap and from said at least one energy storage device being contained in the central portion, and for selectively supplying electric power therein.

35. The wearable computer according to claim 21, further comprising:
a case for housing the electronic module, said case including:
at least one pair of conductive, positive and negative contacts being configured as a first electrical connector, and
at least one rechargeable electrical energy storage device,
wherein said at least one pair of conductive, positive and negative contacts are electrically connected to at least one pair of conductive, positive and negative contacts of said electronic module, and
wherein said at least one electrical energy storage device is electrically connected to at least one pair of conductive, positive and negative contacts of said electronic module, so that said case with said electronic module is independently useable as a portable electronic device apart from the strap;
and
a receptacle area being molded in the central portion, and configured to receive and electrically connect to the case, said receptacle area including:
at least one pair of conductive, positive and negative contacts being configured as a second electrical connector,
wherein said at least one pair of conductive, positive and negative contacts are electrically coupled to at least one pair of conductive, negative and positive insert elements being arranged within said central portion, and
wherein said second electrical connector is used at least in part to removably secure said case, and electrically coupled to the first electrical connector of said case when provided therein, so that the electronic module is electrically connected to at least one energy storage device contained in the strap via said first and second electrical connectors, and supplied with electric power.

36. The wearable computer according to claim 21, further comprising:
a case for housing the electronic module, said case including:
at least one pair of conductive, positive and negative contacts being configured as a first electrical connector, and
at least one rechargeable electrical energy storage device,
wherein said at least one pair of conductive, positive and negative contacts are electrically connected to at least one pair of conductive, positive and negative contacts of said electronic module, and
wherein said at least one electrical energy storage device is electrically connected to at least one pair of conductive, positive and negative contacts of said electronic module, so that said case with said electronic module is independently useable as a portable electronic device apart from the strap;
and
an opening being molded in the central portion, and configured to receive and electrically connect to the case, said opening including:
at least one pair of conductive, positive and negative contacts being configured as a second electrical connector,
wherein said at least one pair of conductive, positive and negative contacts are electrically coupled to at least one pair of conductive, negative and positive insert elements being arranged within said central portion, and
wherein said second electrical connector is used at least in part to removably secure said case, and electrically coupled to the first electrical connector of said case when provided therein, so that the electronic module is electrically connected to at least one energy storage device contained in the strap via said first and second electrical connectors, and supplied with electric power.

37. The wearable computer according to claim 21, further comprising:
a wireless charging module being electrically coupled to at least one energy storage device, and configured to wirelessly collect external energy for charging said energy storage device.

38. The wearable computer according to claim 37,
wherein the wireless charging module comprises:
a receiving coil being configured to collect wireless electromagnetic energy emitted by a transmitting coil of an external power source; and
a conversion module being configured to convert said collected wireless electromagnetic energy into electric power having a predetermined voltage for charging at least one energy storage device.

39. A wearable computer comprising:
an electronic module including:
at least one processor configured to process arbitrary informations,
at least one data memory being configured to store arbitrary data,
at least one control circuitry being configured to perform predetermined functions of the wearable computer, and
at least one pair of conductive, positive and negative contacts being configured as electrical power connection;
a central portion for housing the electronic module therein;
at least one rechargeable electrical energy storage device for providing electric power to the electronic module, said at least one energy storage device including:
at least one battery cell, and
at least one pair of conductive, positive and negative contacts;
a strap for mounting the wearable computer on a body part of a user, and for containing at least one electrical energy storage device therein;
a fastening means for mechanically fastening the strap to the central portion, said fastening means comprising:
a first fastening means for fastening a first end of said strap to a first side of said central portion, and
a second fastening means for fastening a second end of said strap to a second side of said central portion,
wherein the strap end section and the corresponding central portion side section of at least one of the first and second fastening means are complementary shaped in a form-locking way forming a joint;
and
a coupling means for electrically coupling at least one pair of complementary form-locking shaped strap end section and central portion side section of the fastening means, said coupling means further comprises:
at least one pair of conductive, positive and negative members, and
at least one pair of corresponding conductive, positive mating members,
wherein the conductive members of said at least one pair of conductive, positive and negative members are arranged within said end section of the strap, insulated from each other, and electrically coupled to at least one pair of conductive, positive and negative contacts of at least one energy storage device,
wherein the conductive mating members of said at least one pair of conductive, positive and negative mating members are arranged within said side section of the central portion, insulated from each other and from said central portion, and electrically coupled to at least one pair of positive and negative contacts of the electronic module, and
wherein said conductive members are engaging said conductive mating members, so that at least one energy storage device being contained in said strap is electrically coupled to said electronic module being contained in said central portion.

40. The wearable computer according to claim 39,
wherein the electrical coupling of the coupling means is one of (a) a conductive coupling or (b) an inductive coupling.

41. The wearable computer according to claim 39,
wherein at least one battery cell of at least one electrical energy storage device includes one of (a) a metal-ion battery cell, (b) a metal-ion polymer battery cell, (c) a metal-ion air battery cell, (d) a metal-ion ceramic battery cell, (e) a printed circuit metal-ion battery cell, or (f) a metal-ion foil battery cell.

42. The wearable computer according to claim 39,
wherein at least one battery cell of at least one electrical energy storage device is a flexible battery cell.

43. The wearable computer according to claim 39,
wherein the strap is a single, continuous strap.

44. The wearable computer according to claim 39,
wherein the strap further comprises:
a first strap portion containing a first rechargeable electrical energy storage device therein;
a second strap portion containing a second rechargeable electrical energy storage device therein; and
a clasp means for mechanically fastening a first end of said first strap portion and a first end of said second strap portion together, and for removably securing the wearable computer on a body part of a user;
wherein the fastening means further comprises:
a first fastening means for fastening the second end of said first strap portion to the corresponding first side of the central portion; and
a second fastening means for fastening the second end of said second strap portion to the corresponding second side of the central portion,
wherein the strap end section and the corresponding central portion side section of said first fastening means are complementary shaped in a form-locking way forming a joint, and
wherein the strap end section and the corresponding central portion side section of said second fastening means are complementary shaped in a form-locking way forming a joint;
and
wherein the coupling means further comprises:
a first coupling means for electrically coupling the end section of the second end of said first strap portion and the corresponding side section of the first side of the central portion; said first coupling means comprising:
a first pair of conductive, positive and negative members; and
a first pair of corresponding conductive, positive and negative mating members,
wherein the conductive members of said first pair of conductive, positive and negative members are arranged within said end section of said second end of said first strap portion, insulated from each other, and electrically coupled to at least one pair of conductive, positive and negative contacts of said first energy storage device,
wherein the conductive mating members of said first pair of conductive, positive and negative mating members are arranged within said first side section of the central portion, insulated from each other and from said central portion, and electrically coupled to at least one pair of positive and negative contacts of the electronic module, and
wherein said first pair of conductive members are engaging said first pair of conductive mating members, so that said first energy storage device being contained in said first strap portion is electrically coupled to said electronic module being contained in said central portion;
and
a second coupling means for electrically coupling the end section of the second end of said second strap portion and the corresponding side section of the second side of the central portion; said second coupling means comprising:
a second pair of conductive, positive and negative members; and
a second pair of corresponding conductive, positive mating members,
wherein the conductive members of said second pair of conductive, positive and negative members are arranged within said end section of said second end of said second strap portion, insulated from each other, and electrically coupled to at least one pair of conductive, positive and negative contacts of said second energy storage device,
wherein the conductive mating members of said second pair of conductive, positive and negative mating members are arranged within said second side section of the central portion, insulated from each other and from said central portion, and electrically coupled to at least one pair of positive and negative contacts of the electronic module, and
wherein said second pair of conductive members are engaging said second pair of conductive mating members, so that said second energy storage device being contained in said second strap portion is electrically coupled to said electronic module being contained in said central portion.

45. The wearable computer according to claim 39,
wherein at least one segment of the strap further comprises:
an electrically insulating inner layer member being made of a first material for contact with a body part of a user; and
an electrically insulating outer layer member being made of a second material,
wherein at least one of said inner and outer layer members includes extended portions on two opposite sides along the lengthwise direction, said extended portions are extending beyond adjacent edges of at least one energy storage device being contained in said strap segment, and covering at least a portion of adjacent edges of the other layer member, and
wherein at least one energy storage device is sandwiched between said inner layer member and said outer layer member.

46. The wearable computer according to claim 45,
wherein the first and second materials include one of (a) a non-metallic material, such as (b) a natural leather, (c) an artificial leather, (d) a natural elastomer or natural rubber, (e) an artificial elastomer, (f) a synthetic rubber, and (g) a polyurethane, or one of (h) a metallic material.

47. The wearable computer according to claim 39,
wherein at least one portion of the strap is a bracelet, said bracelet comprising:
a plurality of links,
wherein adjacent links of said plurality of links are mechanically coupled together,
wherein at least one link of said plurality of links contains a battery cell of at least one energy storage device,
wherein adjacent battery cells, disposed in respective adjacent links of said plurality of links, are electrically coupled together,
wherein at least one battery cell provides power to the electronic module, and
wherein at least one of said plurality of links is removable from and attachable to said bracelet by a user of the wearable computer to permit the user to adjust a size of said bracelet to a body part of the user.

48. The wearable computer according to claim 39,
wherein the end section of the strap of at least one joint of the fastening means is shaped as a key, and the corresponding side section of the central portion is complementary shaped in a form-locking way as a slot, so that said strap and said central portion are mechanically fastened to each other by plugging said key section into said slot section, and
wherein at least one conductive, positive member of the coupling means is arranged within one of the walls of said key section of the joint, at least one conductive, negative member of the coupling means is arranged within the other wall of said key section, at least one corresponding conductive, positive mating member of the coupling means is arranged within one of the walls of said slot section of the joint, and at least one corresponding conductive, negative mating member is arranged within the other wall of said slot section, so that said strap and said central portion are electrically coupled with each other by engaging said key section and said slot section.

49. The wearable computer according to claim 39,
wherein the end section of the strap of at least one joint of the fastening means is shaped as a notch, and the corresponding side section of the central portion is complementary shaped in a form-locking way as a socket, so that said strap and said central portion are mechanically fastened to each other by putting said notch section and said socket section together, and
wherein at least one conductive, positive member of the coupling means is arranged within one of the walls of said notch section of the joint, at least one conductive, negative member of the coupling means is arranged within the other wall of said notch section, at least one corresponding conductive, positive mating member of the coupling means is arranged within one of the walls of said socket section of the joint, and at least one corresponding conductive, negative mating member is arranged within the other wall of said notch section, so that said strap and said central portion are electrically coupled with each other by putting said notch section and said socket section together.

50. The wearable computer according to claim 39,
wherein the end section of the strap of at least one joint of the fastening means is shaped as a plurality of notches, and the corresponding side section of the central portion is complementary shaped in a form-locking way as a plurality of sockets, so that said strap and said central portion are mechanically fastened to each other by putting said notches section and said sockets section together, and
wherein at least one conductive, positive member of the coupling means is arranged within at least one of the walls of said notches section of the joint, at least one conductive, negative member is arranged within at least one of the other walls of said notches section, at least one corresponding conductive, positive mating member of the coupling means is arranged within at least one of the walls of said sockets section of the joint, and at least one corresponding conductive, negative mating member is arranged within at least one of the other walls of said sockets section, so that said strap and said central portion are electrically coupled with each other by putting said notches section and said sockets section together.

51. The wearable computer according to claim 39,
wherein the end section of the strap of at least one joint of the fastening means is shaped as a tongue, and the corresponding side section of the central portion is complementary shaped in a form-locking way as a groove, so that said strap and said central portion are mechanically fastened to each other by sliding said tongue section into said groove section, and
wherein at least one conductive, positive member and at least one conductive, negative member of the coupling means are arranged within the wall of said tongue section of the joint, and at least one corresponding conductive, positive mating member and at least one corresponding conductive, negative mating member of the coupling means are arranged within the wall of said groove section of the joint, so that said strap and said central portion are electrically coupled with each other by sliding said tongue section into said groove section.

52. The wearable computer according to claim 39,
wherein at least one pair of conductive, positive and negative members of the coupling means are extended along the lengthwise direction and beyond the end section of the strap of at least one joint of the fastening means, and at least one pair of corresponding conductive, positive and negative mating members of the coupling means are configured to receive said pair of extended conductive, positive and negative members when the strap is fastened to the central portion.

53. The wearable computer according to claim 39,
wherein at least one joint of the fastening means further comprises:
a locking means for securing the pair of complementary form-locking shaped strap end section and central portion side section when being engaged with each other.

54. The wearable computer according to claim 53,
wherein the locking means further comprises:
at least one screw through-hole being included in the end section of the strap, and extending along the thickness direction of said strap;
at least one complementary screw hole being included in the side section of the central portion, and extending in line with said screw through-hole and along the thickness direction of said central portion; and
at least one screw being configured to fit into said at least one screw hole,
wherein said screw is inserted through said screw through-hole, and fastened in said screw hole.

55. The wearable computer according to claim 53,
wherein the locking means further comprises:
at least one pin through-hole being included in the end section of the strap, and extending along the thickness direction of said strap;
at least one complementary pin hole being included in the side section of the central portion, and extending in line with said pin through-hole and along the thickness direction of said central portion; and
at least one snap-fit fastener being configured to fit into said at least one pin hole,
wherein said snap-fit fastener is inserted through said pin through-hole, and fastened in said pin hole.

56. The wearable computer according to claim 53,
wherein the locking means further comprises:
a side release fastener being included in the end section of the strap, and having at least one tongue; and
at least one complementary groove being included in the side section of the central portion,
wherein said tongue is fastened in said groove when the strap is fastened to the central portion.

57. The wearable computer according to claim 53,
wherein the locking means further comprises:
at least one pin through-hole being included in the end section of the strap, and extending along the widthwise direction of said strap;
at least one complementary pin hole being included in the side section of the central portion, and extending in line with said pin through-hole and along the widthwise direction of said central portion; and
at least one pin being configured to fit into said at least one pin hole,
wherein said pin is inserted through said pin through-hole, and inserted into said pin hole.

58. The wearable computer according to claim 57,
wherein at least one pin of the locking means further comprises:
at least one hollow barrel section; and
at least one spring-loaded extension section being inserted into said hollow barrel section, and configured as the end of said pin,
wherein said pin is inserted through the pin through-hole, and
wherein said spring-loaded extension section is inserted into the pin hole.

59. The wearable computer according to claim 48,
wherein at least one key shaped end section of the strap further comprises:
a base section being connected to said key section,
wherein said key section and said base section form a hinge, said hinge being configured to pivotably fasten and couple the strap to the central portion.

60. The wearable computer according to claim 49,
wherein at least one joint of the fastening means and the coupling means form a hinge, said hinge being configured to pivotably fasten and couple the strap to the central portion.

61. The wearable computer according to claim 50,
wherein at least one joint of the fastening means and the coupling means form a hinge, said hinge being configured to pivotably fasten and couple the strap to the central portion.

62. The wearable computer according to claim 51,
wherein at least one tongue shaped end section of the strap further comprises:
a base section being connected to said tongue section,
wherein said tongue section and said base section form a hinge, said hinge being configured to pivotably fasten and couple the strap to the central portion.

63. The wearable computer according to claim 39,
wherein at least one joint of the fastening means further comprises:
a sealing means for waterproofing said joint, said sealing means comprising:
at least one seal,
wherein said at least one seal is arranged between the end section of the strap and the side section of the central portion.

64. The wearable computer according to claim 52,
wherein the coupling means further comprises:
a sealing means for waterproofing said coupling means, said sealing means comprising:
at least one seal for each extended conductive, positive and negative member,
wherein said seals are arranged around said members, and between the end section of the strap and the side section of the central portion.

65. The wearable computer according to claim 57,
wherein the locking means further comprises:
a sealing means for waterproofing said locking means, said sealing means comprising:
at least one ring-shaped seal for the end of each pin,
wherein said at least one ring-shaped seal is arranged around said one or more pin ends, and between the end section of the strap and the side section of the central portion.

66. The wearable computer according to claim 44,
wherein the clasp means includes one of (a) a buckle, (b) a buckle clasp with stud, (c) a tang clasp, pin buckle, or buckle with tongue or prong, (c) a ratchet buckle, (d) a deployment clasp or fold-over clasp, such as (e) a deployment clasp with buckle, (f) a deployment clasp with safety, (g) a deployment clasp with at least one push button, and (h) a hidden deployment clasp, dual clasp, or butterfly clasp, (i) a hook and loop fastener, or (j) a releasably secure fastener, such as (k) a quick release fastener, (l) a side release fastener, and (m) a snap-fit fastener.

67. The wearable computer according to claim 39, further comprising:
at least one display device for displaying informative data, said display device being integrated with the central portion, and connected to the electronic module.

68. The wearable computer according to claim 67,
wherein at least one display device includes one of (a) an active display, such as (b) a liquid crystal display, (c) a vacuum field emission display, (d) an electroluminescent display, (e) a plasma liquid crystal display, (f) a light emitting diode display, and (g) a laser display, or one of (h) a passive or reflective display, such as (i) an e-paper and (j) an interferometric modulator display.

69. The wearable computer according to claim 39, further comprising:
at least one rechargeable energy storage device being contained in the central portion; and
a selective switching circuitry for selectively taking out electric power from at least one energy storage device being contained in the strap and from said at least one energy storage device being contained in the central portion, and for selectively supplying electric power therein.

70. The wearable computer according to claim 39, further comprising:
a case for housing the electronic module, said case including:
at least one pair of conductive, positive and negative contacts being configured as a first electrical connector, and
at least one rechargeable electrical energy storage device,
wherein said at least one pair of conductive, positive and negative contacts are electrically connected to at least one pair of conductive, positive and negative contacts of said electronic module, and
wherein said at least one electrical energy storage device is electrically connected to at least one pair of conductive, positive and negative contacts of said electronic module, so that said case with said electronic module is independently useable as a portable electronic device apart from the strap;
and
a receptacle area being molded in the central portion, and configured to receive and electrically connect to the case, said receptacle area including:
at least one pair of conductive, positive and negative contacts being configured as a second electrical connector,
wherein said at least one pair of conductive, positive and negative contacts are electrically coupled to at least one pair of conductive, negative and positive insert elements being arranged within said central portion, and
wherein said second electrical connector is used at least in part to removably secure said case, and electrically coupled to the first electrical connector of said case when provided therein, so that the electronic module is electrically connected to at least one energy storage device contained in the strap via said first and second electrical connectors, and supplied with electric power.

71. The wearable computer according to claim 39, further comprising:
a case for housing the electronic module, said case including:
at least one pair of conductive, positive and negative contacts being configured as a first electrical connector, and
at least one rechargeable electrical energy storage device,
wherein said at least one pair of conductive, positive and negative contacts are electrically connected to at least one pair of conductive, positive and negative contacts of said electronic module, and
wherein said at least one electrical energy storage device is electrically connected to at least one pair of conductive, positive and negative contacts of said electronic module, so that said case with said electronic module is independently useable as a portable electronic device apart from the strap;
and
an opening being molded in the central portion, and configured to receive and electrically connect to the case, said opening including:
at least one pair of conductive, positive and negative contacts being configured as a second electrical connector,
wherein said at least one pair of conductive, positive and negative contacts are electrically coupled to at least one pair of conductive, negative and positive insert elements being arranged within said central portion, and
wherein said second electrical connector is used at least in part to removably secure said case, and electrically coupled to the first electrical connector of said case when provided therein, so that the electronic module is electrically connected to at least one energy storage device contained in the strap via said first and second electrical connectors, and supplied with electric power.

72. The wearable computer according to claim 39, further comprising:
a wireless charging module being electrically coupled to at least one energy storage device, and configured to wirelessly collect external energy for charging said energy storage device.

73. The wearable computer according to claim 72,
wherein the wireless charging module comprises:
a receiving coil being configured to collect wireless electromagnetic energy emitted by a transmitting coil of an external power source; and
a conversion module being configured to convert said collected wireless electromagnetic energy into electric power having a predetermined voltage for charging at least one energy storage device.
